(19) United States
(12) Patent Application Publication
(10) Pub. No.: US 2010/0208348 A1
(43) Pub. Date: Aug. 19, 2010

(54) TUNABLE SPECTRAL FILTRATION DEVICE

(75) Inventors: Gilbert D. Feke, Durham, CT (US); Douglas L. Vizard, Durham, CT (US)

Correspondence Address: Carestream Health, Inc.;ATTN: Patent Legal Staff, 150 Verona Street, Rochester, NY, 14608, US

(73) Assignee: CARESTREAM HEALTH, INC., Rochester, NY (US)

(21) Appl. No.: 12/709,156

(22) Filed: Feb. 19, 2010

Related U.S. Application Data
(63) Continuation-in-part of application No. 12/196,300, filed on Aug. 22, 2008.
Application No. 12/196,300 is a continuation-in-part of application No. 12/201,204, filed on Aug. 29, 2008.
Application No. 12/201,204 is a continuation-in-part of application No. 12/248,958, filed on Oct. 10, 2008.

(51) Int. Cl. G02B 5/28; G02B 5/22

(52) U.S. Cl. 359/578; 359/890

(57) ABSTRACT

A tunable spectral filtration device comprises at least one optical filter for intersecting a first path of converging or diverging light comprising an axis at a first angle of incidence and at least one device positioned to enable a second path of the converging or diverging light to pass through the at least one optical filter at a second angle of incidence. The optical filter comprises at least one coating and is tiltable over a plurality of angles with respect to the axis. The first angle of incidence is opposite in sign to the second angle of incidence, such that the positioning of the at least one optical filter and the at least one device substantially cancels angle-of-incidence dependent spectral broadening and/or polarization dependent spectral broadening of the converging or diverging light.

### CROSS REFERENCE TO RELATED APPLICATIONS

This application is a continuation-in-part of commonly assigned, copending U.S. patent application Ser. Nos. (a) 12/196,300 filed Aug. 22, 2008 by Harder et al. entitled APPARATUS AND METHOD FOR MULTI-MODAL IMAGING USING NANOPARTICLE MULTI-MODAL IMAGING PROBES (Docket 93047); (b) 12/201,204 filed Aug. 29, 2008 by Hall et al. entitled APPARATUS AND METHOD FOR MULTI-MODAL IMAGING USING NANOPARTICLE MULTI-MODAL IMAGING PROBES (Docket 93047A); and 12/248,958 filed Oct. 10, 2008 by Feke et al. entitled TUNABLE SPECTRAL FILTRATION DEVICE (Docket 94762), the disclosure of each of which is incorporated by reference into the present specification.

### FIELD OF THE INVENTION

This invention relates, generally, to spectral filtration devices and more particularly to such devices that are tunable to adjust the spectral output or transmitted frequencies of the device.

### BACKGROUND OF THE INVENTION

Various types of spectral filtration devices are known for illumination systems used to deliver electromagnetic radiation to a subject and for detection systems that receive electromagnetic radiation from a subject. In either application, known spectral filtration devices selectively attenuate the transmitted frequencies of electromagnetic radiation in the range or spectrum of optical wavelengths. These ranges include from ultraviolet, through visible, to near-infrared wavelengths, which include the portion of the electromagnetic spectrum producing photoelectric effects, referred to herein as “light”.

Spectral filtration of light is performed in basically two ways, dispersion-based techniques and filter-based techniques. In the dispersion-based approach, a radiation dispersion device such as a prism or diffraction grating is used to separate the incident polychromatic light into its spectral contents, which are then spatially filtered for illumination or detection purposes. Dispersion-based techniques are often problematic with regard to achieving adequate spectral selectivity and adequate transmission efficiency.

In the filter-based approach, various types of optical filters are positioned to intersect a light path. Filters of the bandpass type substantially attenuate transmitted optical wavelengths which are less than a “cut-on” wavelength and greater than a “cut-off” wavelength, and do not substantially attenuate transmitted optical wavelengths in between the “cut-on” and “cut-off” wavelengths. Filters of the short pass type substantially attenuate transmitted optical wavelengths that are greater than a “cut-off” wavelength. Filters of the long pass type substantially attenuate transmitted optical wavelengths that are less than a “cut-on” wavelength. Often a bandpass filter is devised from a combination or construction of a shortpass and a longpass filter. Filters of the notch type do not substantially attenuate transmitted optical wavelengths that are less than a “cut-off” wavelength and greater than a “cut-on” wavelength, and substantially attenuate transmitted optical wavelengths in between the “cut-on” and “cut-off” wavelengths. Often these filters are mounted in a filter selection member such as a rotating wheel or translating slider to enable selected filters to be positioned at a reproducible location to intersect a light path.

Filters are often comprised of transparent optical substrates upon which is deposited a multilayer interference filter coating which determines the spectral properties of the filter. Discrete filters have a coating that is substantially uniform across the clear aperture of the filter. Circularly variable filters and linearly variable filters have coatings that spatially vary by design across the clear aperture of the filter so that when the filter is rotated or translated with respect to a light path, the transmitted optical wavelengths vary accordingly. Liquid crystal tunable filters and acousto-optic tunable filters have also been developed.

In order to be useful in most applications, an optical filter that is designed to transmit certain wavelengths must sufficiently reject all other wavelengths for which source energy and detector sensitivity both exist. That is, light of all other wavelengths outside these certain wavelengths and within a range set by the limits of the source and the detector must be blocked in order for the filter to operate with the given source and detector. In the case of induced transmittance or Fabry-Perot-type metal dielectric filters, the rejection occurs naturally and such filters can be designed with wide-band blocking without complicating the design of the filter.

All-dielectric filters can be much more environmentally stable than metal dielectric filters and are preferred in many applications. Blocking requires stacks of layers, each stack blocking a specific range of wavelengths. Several quarter wave optical thickness (QWOT) stacks generally provide this blocking. A quarter wave stack is characterized by its center wavelength in that the stack blocks light by reflection over a wavelength range around its center wavelength. The width of the wavelength range of the stack depends on the stack configuration and the ratio of the indices of refraction of the two coated materials used in the stack. The depth of blocking is controlled by the number of layers in the stack.

It is not uncommon for the all-dielectric filters to have upwards of 200 total layers. Typically, only a relatively few such layers can be formed on a single surface. Thus, these layers must be distributed over several surfaces, for example, over two to four surfaces on one or two substrates, to minimize and balance coating stresses. Otherwise, the use of two substrates with a small air space is acceptable, and in a number of applications it is perfectly acceptable to coat two surfaces of the same substrate.

The optical wavelengths transmitted by a given interference filter through a given cross-section of its clear aperture are dependent upon both the angle of the incident light with respect to the multilayer interference coating and, in many cases, also the polarization of the incident light with respect to the angle. This dependence to a near approximation is described by the formula given as

λ=λ₀*(1−((sin φ)/N))^{0.5} Equation 1

where φ is the magnitude of the angle of incidence, λ is the wavelength of the particular spectral feature of interest at angle of incidence with magnitude φ, λ₀ is the wavelength of the particular spectral feature of interest 0 degree angle of incidence, N is the effective refractive index of the coating for the polarization state of the incident light and * indicates multiplication. The effective refractive index of a coating is determined by the coating materials used and the sequence of thin-film layers in the coating. In the case of collimated light where all the rays of light are parallel, tilting the filter with respect to the light path axis causes the transmission spectrum of the filter to shift to shorter wavelengths. In the case where the light has divergent or convergent components, the rays of light which propagate at a nonzero angle with respect to the filter normal will experience a transmitted spectrum attenuation profile which is shifted to shorter wavelengths. In the case for light whose polarization state is a superposition of nonzero parallel and perpendicular components relative to the tilt axis, the parallel component, in many cases, experiences a different shift of the transmission spectrum than the perpendicular component due to N being different for the different components.

Although circularly and linearly variable filters, liquid crystal tunable filters, and acousto-optic tunable filters enable continuous wavelength tuning, such elements are relatively complicated and therefore relatively expensive to manufacture, and in many cases not tolerant to high power optical throughput. Devices have been developed to advantageously use the angle-of-incidence dependent behavior of interference filters to achieve wavelength tuning using a discrete filter with a uniform multilayer interference coating. Devices described in the prior art involve tilting a single discrete interference filter that is positioned to intersect a light path, or equivalently involve tilting a light path that intersects a single discrete interference filter. The tuning range of such devices is advantageously larger when the effective index N of the multilayer interference coating is smaller.

Although tilting a single interference filter is effective for controlling the transmission spectrum when the light is collimated, the approach loses its effectiveness when the light is non-collimated, i.e., has divergent or convergent angular components. This loss occurs because the angles-of-incidence upon tilting are decreased for light rays which propagate in directions away from the direction of tilt and increased for light rays which propagate in directions toward the angle of tilt, so that the light rays with decreased angles of incidence experience a transmitted spectrum attenuation profile which is shifted to longer wavelengths relative to the light path axis and the light rays with increased angles of incidence experience a transmitted spectrum attenuation profile which is shifted to shorter wavelengths relative to the light path axis, respectively. The result is a smearing of the transmitted spectrum attenuation profile. This smearing is advantageously smaller when the effective index N of the multilayer interference coating is larger, but a larger effective index N results in a smaller tuning range, which is a disadvantage. Also, in many cases, the approach loses its effectiveness for light whose polarization state is a superposition of nonzero parallel and perpendicular components relative to the tilt axis because the parallel component, in many cases, experiences a different shift of the transmission spectrum than the perpendicular component due to N being different for the different components, thereby causing smearing of the transmitted spectrum attenuation profile.

Furthermore, light rays transmitted through a single tilted filter are spatially shifted with respect to the incident light rays due to the effect of refraction of light through the optically thick filter. This translational shift is a function of the tilt angle, so when the filter is tilted to tune the transmitted optical wavelengths, the translational shift of the light rays changes. This effect is often undesirable in optical systems because of loss of alignment of the light rays with downstream optics, for example resulting in variable attenuation of transmission through downstream optics, image shift on an imaging sensor, etc. Furthermore, since the depth of blocking is controlled by the number of layers in the filter stack, the construction of a single filter to attain adequate depth of blocking may be costly. Furthermore, the transmitted optical wavelengths of a single filter are limited to those available by tilting the filter with respect to a light path.

Accordingly, there is a need for a tunable spectral filtration device that overcomes or avoids the above problems and limitations. As an example, there is a need for low-cost light sources with sufficient spectral purity for applications such as wavelength-multiplexed optical communication and fluorescence sensing and imaging. Laser sources provide sufficient spectral purity, often without the need to perform spectral filtration, and a high degree of polarization, but they are often undesirable due to high cost. In addition, optical coherence effects characteristic of lasers often lead to system artifacts, such as speckle. Light emitting diodes (LEDs), whether monochromatic, polychromatic, or “white” (i.e., phosphor-coated), are typically low-cost and are not optically coherent. Monochromatic LEDs have a narrow spectral bandwidth, but do not provide the spectrally-pure light output necessary for many applications. Furthermore, LEDs do not provide collimated light output, and the degree of polarization of their light output is typically low, so therefore there is a need for a low-cost spectral filtration device for LEDs that can accommodate their light output.

### SUMMARY OF THE INVENTION

The tunable spectral filtration devices of the present invention address the foregoing needs by substantially cancelling angle-of-incidence dependent spectral broadening and/or polarization dependent spectral broadening.

In one embodiment, the tunable spectral filtration device comprises at least one optical filter for intersecting a first path of converging or diverging light comprising an axis at a first angle of incidence and at least one device positioned to enable a second path of converging or diverging light to pass through the at least one optical filter at a second angle of incidence. The optical filter comprises at least one coating and is tiltable over a plurality of angles with respect to the axis of the light path. The first angle of incidence is opposite in sign to the second angle of incidence, and the positioning of the at least one optical filter and the at least one device substantially cancels angle-of-incidence dependent spectral broadening and/or polarization dependent spectral broadening of the converging or diverging light.

In a more specific form of this embodiment, the tunable spectral filtration device comprises a first optical filter for intersecting a first path of converging or diverging light comprising an axis at a first angle of incidence and a second optical filter positioned to intersect the light path at a second angle of incidence. One or both optical filters exhibit substantially no polarization splitting. Filters of this type include those commercially available from Semrock, Inc. under the trademark VersaChrome and are tiltable over a plurality of angles with respect to the axis of the light path. The first angle of incidence is opposite in sign to the second angle of incidence, and the positioning of the first and second optical filters substantially cancels angle-of-incidence dependent spectral broadening.

In yet another more specific form of the above general embodiment, the tunable spectral filtration device comprises the at least one optical filter and the at least one device, wherein the at least one device comprises a partially reflective surface positioned to redirect the converging or diverging light and a reflective surface positioned to reflect the converging or diverging light back through the optical filter. The optical filter comprises at least one coating and is tiltable over a plurality of angles with respect to the axis of the light path. The positioning of the at least one optical filter and the partially reflective and reflective surfaces cancels angle-of-incidence dependent spectral broadening and/or polarization dependent spectral broadening of the converging or diverging light.

In still another embodiment of the present invention, a tunable spectral filtration device comprises at least one optical filter for intersecting a first path of converging or diverging light comprising an axis at a first angle of incidence and at least one device positioned to enable a second path of the converging or diverging light to pass through the at least one optical filter at a second angle of incidence. The at least one optical filter is capable of exhibiting substantially no polarization splitting and is tiltable over a plurality of angles with respect to the axis of the light path. The first angle of incidence is opposite in sign to the second angle of incidence, and the positioning of the at least one optical filter and the at least one device substantially cancels angle-of-incidence dependent spectral broadening.

In another aspect, the present invention relates to methods of improving the spectral quality of filtered converging or diverging light. The methods comprise providing converging or diverging light from a light source; providing a path for the converging or diverging light through at least one optical filter comprising an axis; and improving the spectral quality of the converging or diverging light by substantially canceling angle-of-incidence dependent spectral broadening and/or polarization dependent spectral broadening. The at least one optical filter of this embodiment comprises at least one coating and is tiltable over a plurality of angles with respect to the axis of the light path.

The foregoing embodiments may include various additional features and structures. For example, the first angle of incidence may be substantially equal in magnitude to the second angle of incidence. The partially reflective surface may comprise a polarization-insensitive beamsplitter and the reflective surface may comprise a mirror. The foregoing embodiments may further comprise a light source selected from the group consisting of a light emitting diode, a multicolor light emitting diode, a phosphor-coated light emitting diode, a halogen lamp, a xenon lamp and combinations thereof.

Additionally, the first and second optical filters may be substantially identical and set in various positions, including in series to intersect the converging or diverging light. The first optical filter may be tilted at an angle opposite in sign to the tilt angle of the second optical filter. Additionally, the first optical filter may be tilted at an angle with equal magnitude to the second optical filter and/or the tilt angles of the first and second optical filters may be substantially identical. Furthermore, the first and second filters may be mounted in filter selection members and selectable from a collection of optical filters mounted in such selection members. Finally, the optical filters may exhibit substantially no polarization splitting, provide a steep edge absorption at angles of incidence ranging in magnitude from 0° to 60° and/or provide a substantially uniform transmission spectrum.

### BRIEF DESCRIPTION OF THE DRAWINGS

For a fuller understanding of the nature and objects of the invention, reference should be made to the following detailed description, taken in connection with the accompanying drawings.

FIGS. 1A and 1B are a pair of graphs for reference showing the transmittance for S and P polarizations of a 542 nm central wavelength, 20 nm bandpass filter as functions of wavelength and angle of incidence.

FIG. 2A illustrates a known configuration wherein a filter is intersecting an unpolarized collimated light path at normal incidence.

FIG. 2B illustrates transmittance vs. wavelength of the 542 nm central wavelength, 20 nm bandpass filter for the configuration of FIG. 2A.

FIG. 3A illustrates a known configuration wherein a filter is intersecting an unpolarized non-collimated light path at normal incidence.

FIG. 3B illustrates transmittance vs. wavelength of the 542 nm central wavelength, 20 nm bandpass filter for the configuration of FIG. 3A.

FIG. 4A illustrates a known configuration wherein a filter is intersecting an unpolarized collimated light path at a pitch angle of −30 degrees.

FIG. 4B illustrates transmittance vs. wavelength of the 542 nm central wavelength, 20 nm bandpass filter for the configuration of FIG. 4A.

FIG. 5A illustrates a configuration wherein a filter is intersecting an unpolarized non-collimated light path at a pitch angle of −30 degrees.

FIG. 5B illustrates transmittance vs. wavelength of the 542 nm central wavelength, 20 nm bandpass filter for the configuration of FIG. 5A.

FIG. 6A is an illustration of a configuration wherein two filters are intersecting an unpolarized non-collimated light path, both at pitch angle of −30 degrees.

FIG. 6B illustrates transmittance vs. wavelength of the 542 nm central wavelength, 20 nm bandpass filter for the configuration of FIG. 6A.

FIG. 7A illustrates an embodiment of the invention comprising a configuration wherein two filters are intersecting an unpolarized non-collimated light path, one at a pitch angle of −30 degrees and the other at a pitch angle of +30 degrees.

FIG. 7B illustrates transmittance vs. wavelength of the 542 nm central wavelength, 20 nm bandpass filter for the configuration of FIG. 7A.

FIG. 7C illustrates an embodiment of the invention comprising the configuration of FIG. 7A wherein the layers of the multilayer interference coatings are evenly distributed between the two filters.

FIG. 8A illustrates another embodiment of the invention comprising a configuration wherein two filters are intersecting an unpolarized non-collimated light path, one at a pitch angle of −30 degrees and the other at a yaw angle of −30 degrees.

FIG. 8B illustrates transmittance vs. wavelength of the 542 nm central wavelength, 20 nm bandpass filter for the configuration of FIG. 8A.

FIG. 9A illustrates a further embodiment of the invention comprising a configuration wherein four filters are intersecting an unpolarized non-collimated light path, one at a pitch angle of −30 degrees, another at a pitch angle of +30 degrees, another at a yaw angle of +30 degrees, and another at a yaw angle of −30 degrees.

FIG. 9B illustrates transmittance vs. wavelength of the 542 nm central wavelength, 20 nm bandpass filter for the configuration of FIG. 9A.

FIG. 10 is a graph showing transmittance vs. wavelength of the 542 nm central wavelength, 20 nm bandpass filter for all the configurations of FIGS. 2B, 3B, 4B, 5B, 6B, 7B, 8B and 9B.

FIG. 11 illustrates yet another embodiment of the invention wherein four filters are selected from loose piece collections of filters, tilted and fixedly mounted, whereby the selection and tilting are made permanent.

FIG. 12A illustrates still another embodiment of the invention wherein four filters are selected from loose piece collections of filters, tilted and adjustably mounted, whereby the selection and tilting are adjustable.

FIG. 12B illustrates schematically the adjustable fixture of FIG. 12A.

FIG. 13 illustrates an embodiment of the invention wherein four filters are selected from collections of filters mounted in rotatable wheels, and tilted, whereby the selection and tilting are adjustable.

FIG. 14 illustrates an embodiment of the invention wherein four filters are selected from collections of filters mounted in translatable sliders, and tilted, whereby the selection and tilting are adjustable.

FIG. 15 illustrates an embodiment wherein four filters are selected, tilted, and positioned intersecting a light path from a light source, the filtered output light being directed toward a capture device.

FIG. 16 illustrates an embodiment of the invention comprising a configuration where two VersaChrome filters are intersecting an unpolarized non-collimated light path, one at a pitch angle of −30 degrees and the other at a pitch angle of +30 degrees.

FIG. 17 illustrates yet another embodiment of the invention where two VersaChrome filters are selected from loose piece collections of VersaChrome filters, tilted and fixedly mounted, whereby the selection and tilting are made permanent.

FIG. 18A illustrates still another embodiment of the invention where two VersaChrome filters are selected from loose piece collections of VersaChrome filters, tilted and adjustably mounted, whereby the selection and tilting are adjustable.

FIG. 18B illustrates schematically the adjustable fixture of FIG. 18A.

FIG. 19 illustrates an embodiment of the invention where two VersaChrome filters are selected from collections of VersaChrome filters mounted in rotatable wheels, and tilted, whereby the selection and tilting are adjustable.

FIG. 20 illustrates an embodiment of the invention where two VersaChrome filters are selected from collections of VersaChrome filters mounted in translatable sliders, and tilted, whereby the selection and tilting are adjustable.

FIG. 21 illustrates an embodiment wherein two VersaChrome filters are selected, tilted, and positioned intersecting a light path from a light source, the filtered output light being directed toward a capture device.

FIG. 22 illustrates an embodiment of the invention where a non-collimated light path is diverted by a polarization-insensitive beamsplitter into a filter at a given pitch angle, and then reflected by a mirror back through the filter toward a capture device.

### DETAILED DESCRIPTION OF THE INVENTION

The invention has been described in detail with particular reference to certain preferred embodiments thereof, but it will be understood that variations and modifications can be effected within the spirit and scope of the invention.

In general, the tunable spectral filtration device of the presently claimed invention comprises at least one optical filter for intersecting a first path of converging or diverging light comprising an axis at a first angle of incidence and at least one device positioned to enable a second path of converging or diverging light to pass through the at least one optical filter at a second angle of incidence. The optical filter comprises at least one coating and is tiltable over a plurality of angles with respect to the axis of the light path. In certain embodiments, the at least one device may comprise a second optical filter, which is positioned in series with the first, while in others, the at least one device may comprise a beamsplitter for diverging the first light path and a mirror for reflecting the light path back through the optical filter.

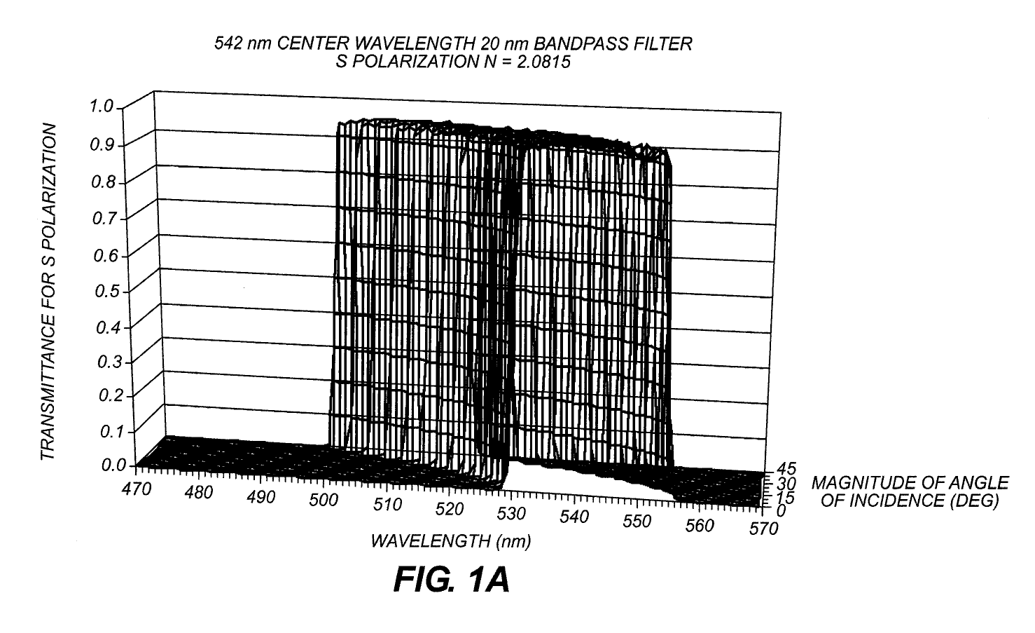

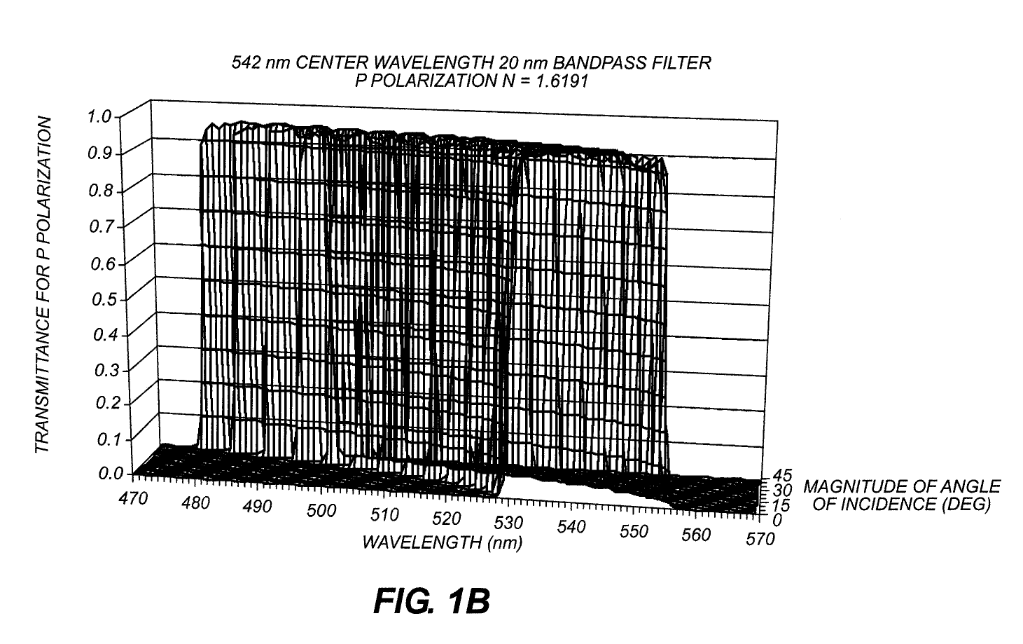

FIGS. 1A and B respectively show the transmittance for S and P polarizations of a 542 nm central wavelength, 20 nm bandpass filter as functions of wavelength and angle of incidence as calculated using equation (1). The graphs are based on published product data from Semrock, Inc., for 0 degrees angle-of-incidence and exemplary values for the effective index for S and P polarizations as suggested in published information by Semrock, Inc. Data published by Semrock, Inc., also indicates that Equation 1 is a valid approximation out to at least 45 degree angle-of-incidence. A filter of the bandpass type was selected for illustration of the preferred embodiments because this type is comprised of both a cut-on edge and a cut-off edge, and the behavior of these edges is individually applicable to filters of other types. FIGS. 1A and B show that for a light ray with any given combination of wavelength, angle-of-incidence, and polarization components, the transmittance is mostly either rather high or rather low, i.e., that the transmittance is a sharp function of wavelength, angle-of-incidence, and polarization. FIGS. 1A and B are provided as a reference for the detailed description of the preferred embodiments.

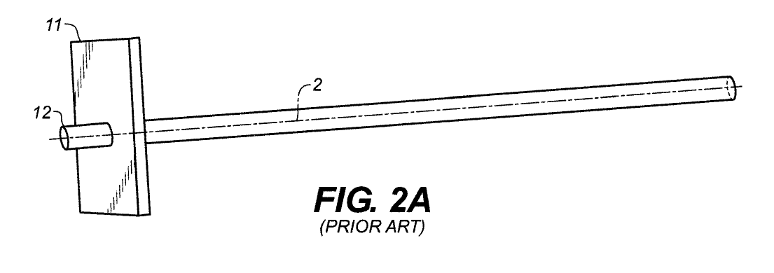

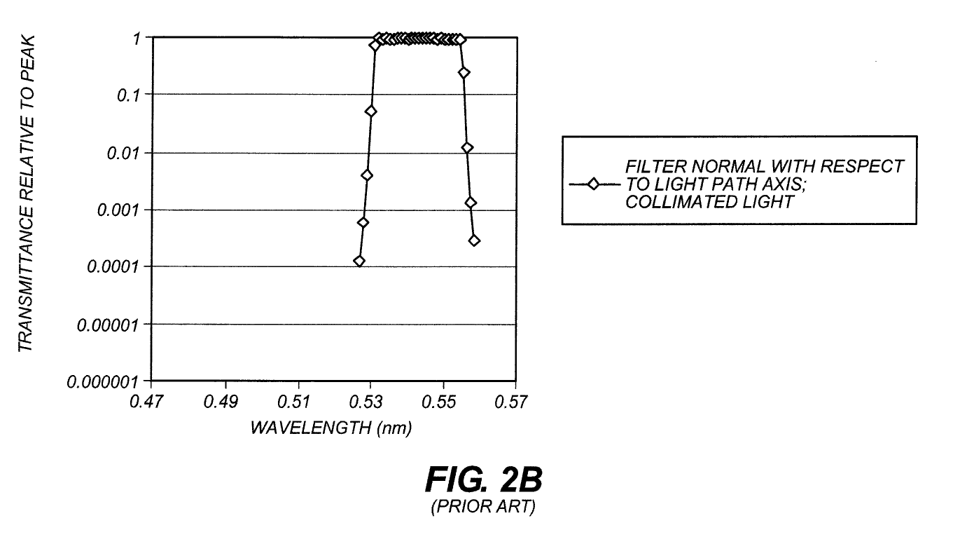

FIG. 2A shows a known configuration wherein a filter 11 is intersecting an unpolarized collimated light path 12 at normal, i.e., 0 degree angle of, incidence with respect to the incident light path axis 2. In this configuration the transmitted light path axis does not undergo a translational shift. The transmittance spectrum of this configuration is represented by the average of the 0 degree angle-of-incidence slices of the S and P polarization graphs shown in FIGS. 1A and B, which are in fact identical. FIG. 2B shows transmittance relative to peak vs. wavelength of the 542 nm central wavelength, 20 nm bandpass filter as described in FIGS. 1A and B for the configuration in FIG. 2A as simulated by TracePro optical modeling software from Lambda Research Corporation using a circular grid source.

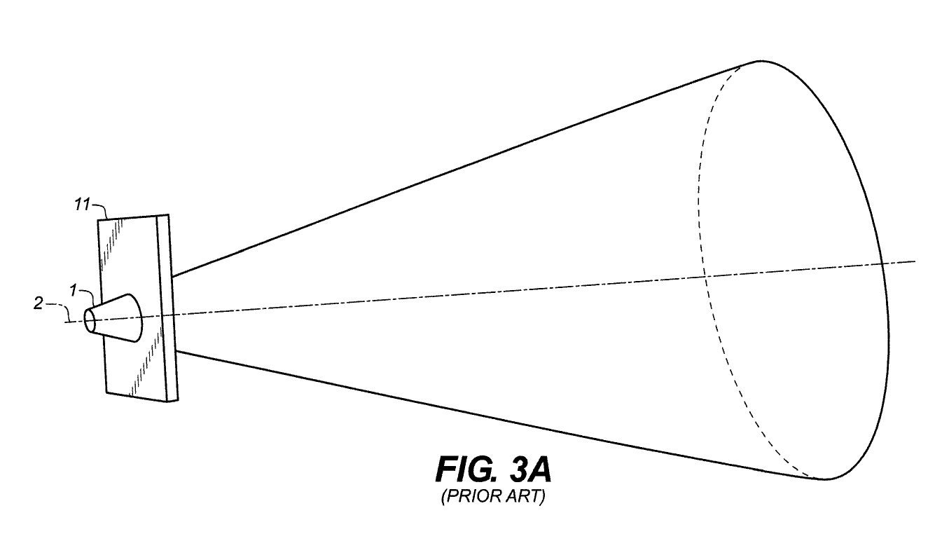

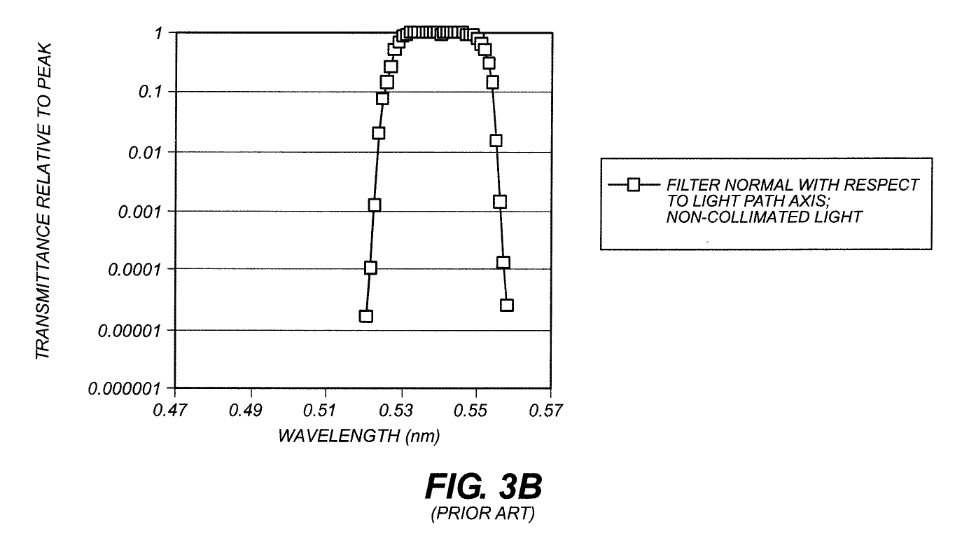

FIG. 3A shows a known configuration wherein filter 11 is intersecting an unpolarized non-collimated light path 1 at normal, i.e., 0 degree angle of, incidence with respect to incident light path axis 2. In this configuration the transmitted light path axis does not undergo a translational shift. For the purpose simulating a representative configuration the non-collimated light was given a Lambertian angular weighting within a 15 degree half cone. The transmittance spectrum of this configuration is therefore represented by the Lambertian weighted average over angle of the average of the S and P polarization slices between 0 and 15 degree angle-of-incidence as shown in FIGS. 1A and B. FIG. 3B shows transmittance relative to peak vs. wavelength of the 542 nm central wavelength, 20 nm bandpass filter as described in FIGS. 1A and B for the configuration in FIG. 3A as simulated using a circular grid source. The resulting central wavelength is shown to have shifted slightly to shorter wavelength compared to the central wavelength of the configuration shown in FIG. 2A. This is due to weighting of the spectrum by nonzero angle-of-incidence light rays. Furthermore, it is shown that the resulting bandwidth is increased compared to the bandwidth of the configuration shown in FIG. 2A. This is due to the range of the nonzero angles of incidence.

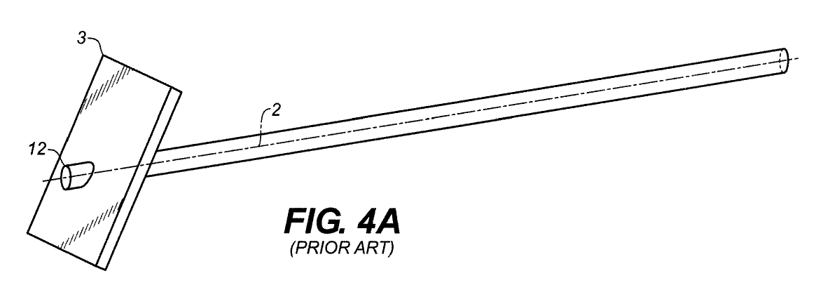

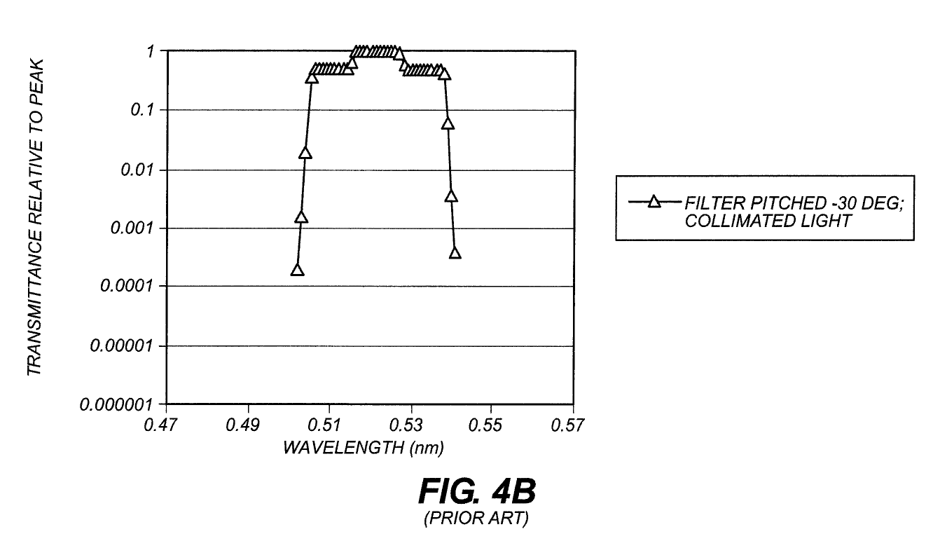

FIG. 4A shows a known configuration wherein a filter 3 is intersecting unpolarized collimated light path 12 at a pitch angle of −30 degrees with respect to incident light path axis 2. In this configuration the transmitted light path axis undergoes a translational shift. The transmittance spectrum of this configuration is represented by the average of the 30 degree angle-of-incidence slices of the S and P polarization graphs shown in Figures A and B. FIG. 4B shows transmittance relative to peak vs. wavelength of the 542 nm central wavelength, 20 nm bandpass filter as described in FIGS. 1A and B for the configuration in FIG. 4A as simulated using a circular grid source. The resulting central wavelength is shown to have shifted significantly to shorter wavelength compared to the central wavelength of the configuration shown in FIG. 2A. This is due to the large angle of incidence. Furthermore, the resulting bandwidth is shown to have increased compared to the bandwidth of the configuration shown in FIG. 2A, with a characteristic “ziggurat” shape of the transmittance spectrum, due to the difference in the effective index for the S and P polarization components.

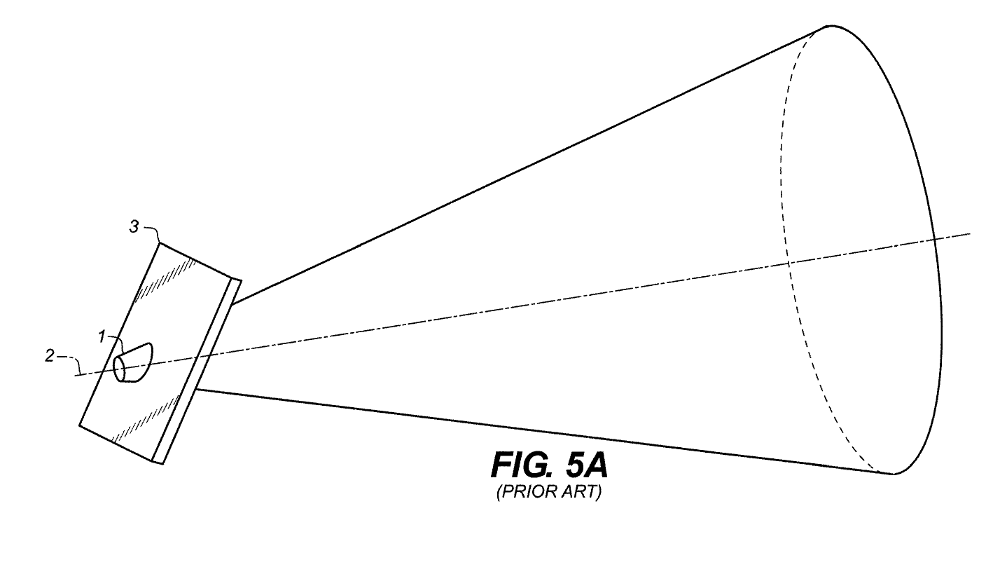

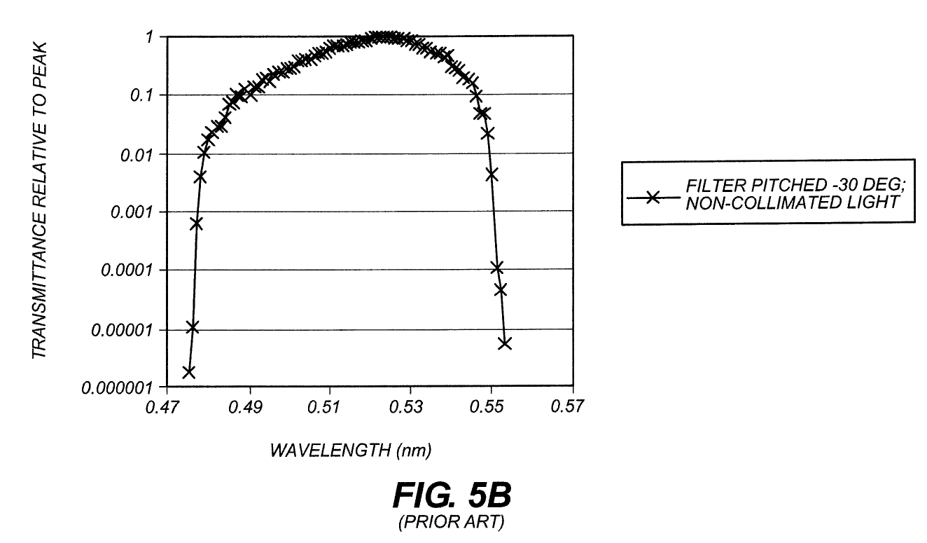

FIG. 5A shows a known configuration wherein filter 3 is intersecting unpolarized non-collimated light path 1 at a pitch angle of −30 degrees with respect to incident light path axis 2. In this configuration the transmitted light path axis undergoes a translational shift. For the purpose simulating a representative configuration the non-collimated light was given a Lambertian angular weighting within a 15 degree half cone. The transmittance spectrum of this configuration is therefore represented by the Lambertian weighted average over angle of the average of the S and P polarization slices between 15 degree and 45 degree angle-of-incidence as shown in FIGS. 1A and B. FIG. 5B shows transmittance relative to peak vs. wavelength of the 542 nm central wavelength, 20 nm bandpass filter as described in FIGS. 1A and B for the configuration in FIG. 5A as simulated using a circular grid source. The resulting central wavelength is shown to have shifted slightly to shorter wavelength compared to the central wavelength of the configuration shown in FIG. 4A. This is due to the contribution of angles of incidence greater than the average angle of incidence, i.e., between 30 degrees and 45 degrees, which experience a relatively faster shift to shorter wavelengths of the transmittance spectrum with increasing angle of incidence, weighing the average transmittance spectrum compared to the contribution of angles of incidence less than the average angle of incidence, i.e., between 15 degrees and 30 degrees, which experience a relatively slower shift to shorter wavelengths of the transmittance spectrum with increasing angle of incidence. Furthermore, the resulting bandwidth is shown to have increased compared to the bandwidth of the configuration shown in FIG. 4A, with the characteristic “ziggurat” shape of the transmittance spectrum having been smeared over wavelength, due to the range of the angles of incidence.

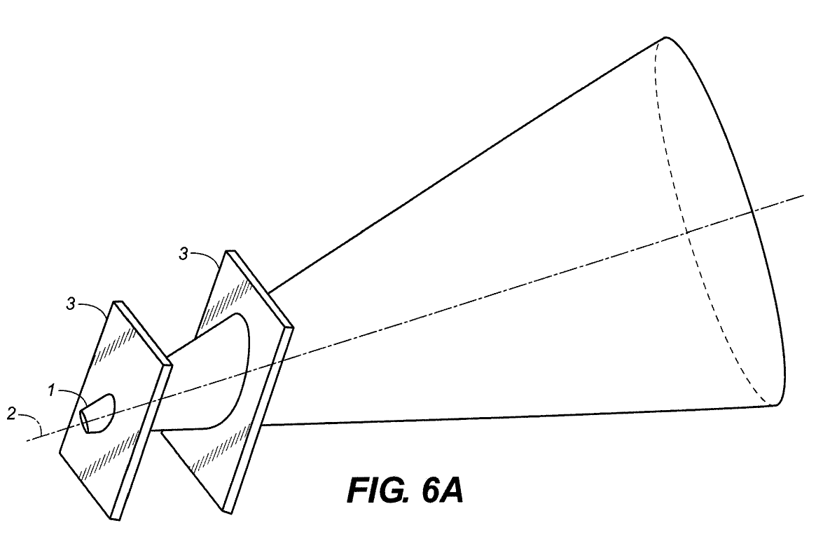

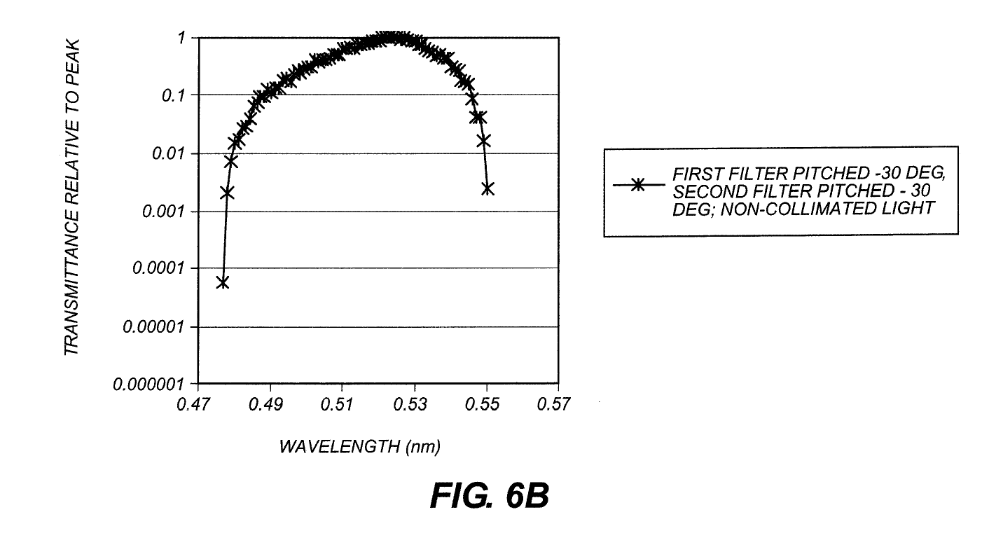

FIG. 6A shows a configuration wherein two identical filters 3 and 3 are intersecting unpolarized non-collimated light path 1 at a pitch angle of −30 degrees with respect to incident light path axis 2. In this configuration the transmitted light path axis undergoes a translational shift upon transmission through the first filter and another translational shift of the same magnitude and direction upon transmission through the second filter. For the purpose of simulating a representative configuration, the non-collimated light was given a Lambertian angular weighting within a 15 degree half cone. The transmittance spectrum of this configuration is therefore represented by the Lambertian weighted average over angle of the square of the average of the S and P polarization slices between 15 degree and 45 degree angle-of-incidence as shown in FIGS. 1A and B.

FIG. 6B shows transmittance relative to peak vs. wavelength of the 542 nm central wavelength, 20 nm bandpass filter as described in FIGS. 1A and B for the configuration in FIG. 6A as simulated using a circular grid source. FIG. 6B shows that the transmittance spectrum is very similar to that shown in FIG. 5B, with only a very slight decrease in transmittance at the extremes of the spectrum. This is because every incident ray with a given wavelength, angle of incidence, and polarization state experiences a sharp transmittance spectrum as shown in FIGS. 1A and B, so that a light ray that this transmitted by the first filter with near unity transmittance relative to peak in fact has its properties preserved upon incidence onto the second filter, which also transmits the light ray with near unity transmittance relative to peak.

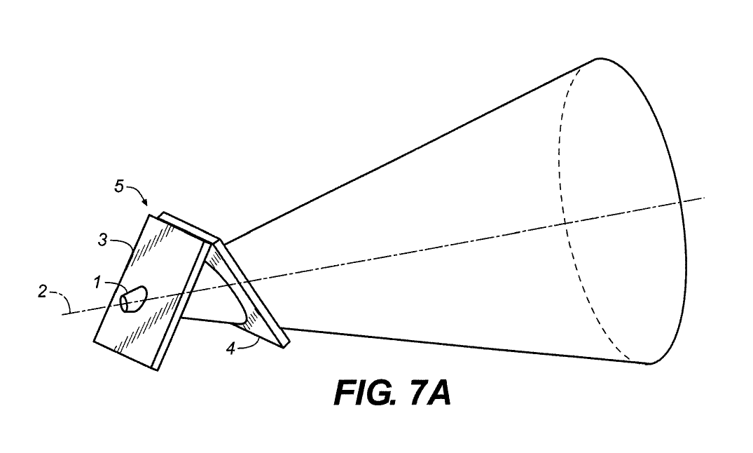

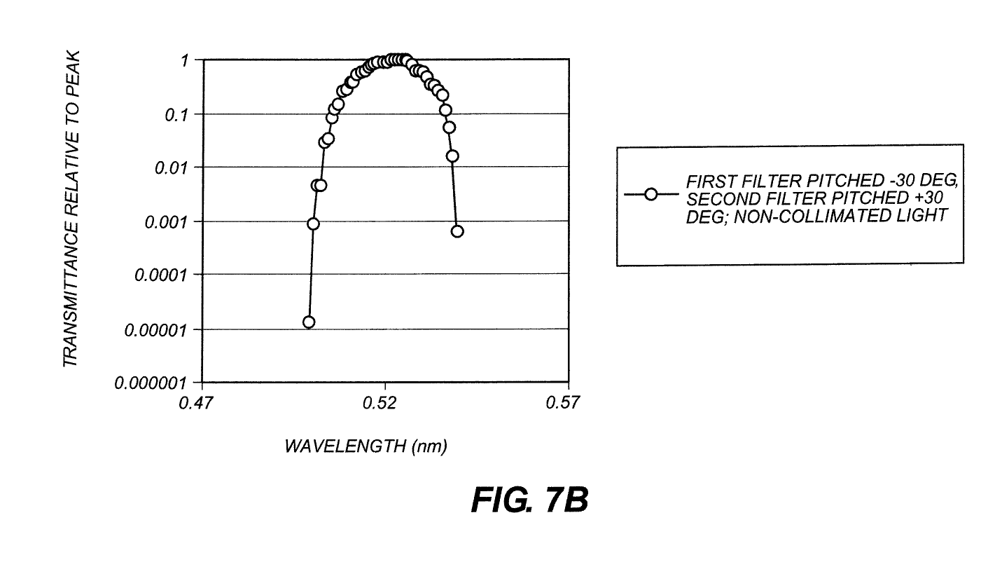

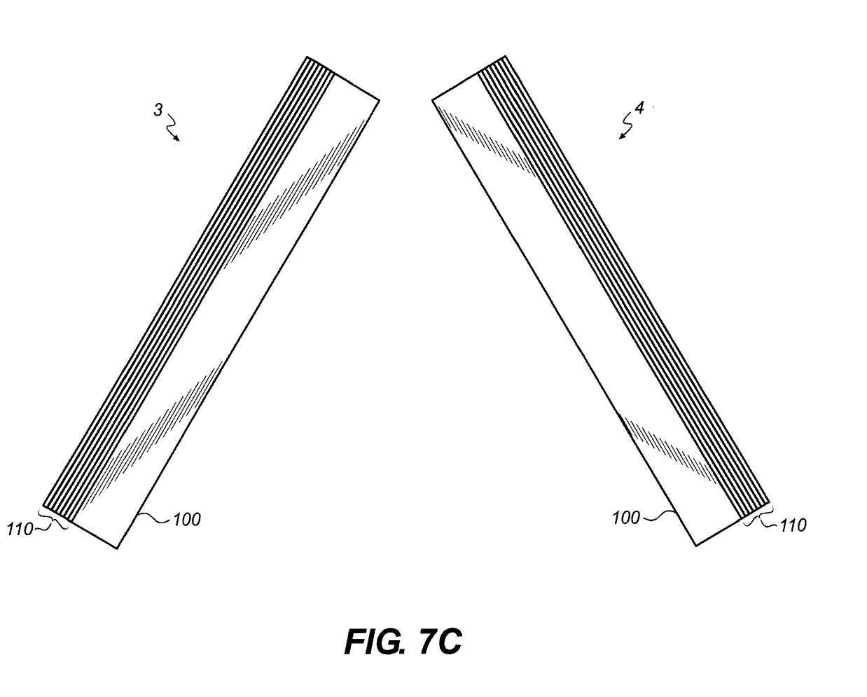

FIG. 7A shows an embodiment wherein two identical filters are intersecting unpolarized non-collimated light path 1, one filter 3 at a pitch angle of −30 degrees and the other filter 4 at a pitch angle of +30 degrees with respect to incident light path 2. In this configuration the transmitted light path axis undergoes a translational shift upon transmission through the first filter and another translational shift of the same magnitude and opposite direction upon transmission through the second filter, the result being zero net translational shift. These two filters comprise a matched pair 5 oppositely tilted in pitch angle according to the invention. For the purpose of simulating a representative configuration, the non-collimated light was given a Lambertian angular weighting within a 15 degree half cone. FIG. 7B shows transmittance relative to peak vs. wavelength of the 542 nm central wavelength, 20 nm bandpass filter as described in FIGS. 1A and B for the configuration in FIG. 7A as simulated using a circular grid source. FIG. 7B shows that the resulting bandwidth is decreased compared to the bandwidth of the configuration shown in FIGS. 5A and 6A. This is because any given light ray transmitted through the first filter at a pitch angle magnitude of the absolute value of (−30+x) degrees is incident upon the second filter at a pitch angle magnitude of the absolute value of (30+x) degrees, where x is between −15 degrees and 15 degrees. Therefore some light rays with wavelengths longer than the central wavelength are transmitted by the first filter because of a relatively smaller magnitude of angle of incidence but are rejected by the second filter because of a relatively larger magnitude of angle of incidence; and some light rays with wavelengths shorter than the central wavelength are transmitted by the first filter because of a relatively larger magnitude of angle of incidence but are rejected by the second filter because of a relatively smaller magnitude of angle of incidence.

Those skilled in the art will appreciate that a sufficient number of layers in a multilayer interference coating are necessary to achieve a desired spectral transmission profile, and that filter cost increases with increasing number of layers as required for high-performance filters. The pairing of filters as shown in FIG. 7A promotes distribution of the requisite layers over the pair, so that the number of layers, and hence the cost of each filter, may be minimized. FIG. 7C (not drawn to scale) shows an embodiment wherein the layers 110 of the multilayer interference coatings on substrates 100 are evenly distributed between two identical filters of FIG. 7A to achieve the desired spectral profile. However, those skilled in the art will appreciate that in some applications the distribution of the layers need not be exactly evenly distributed.

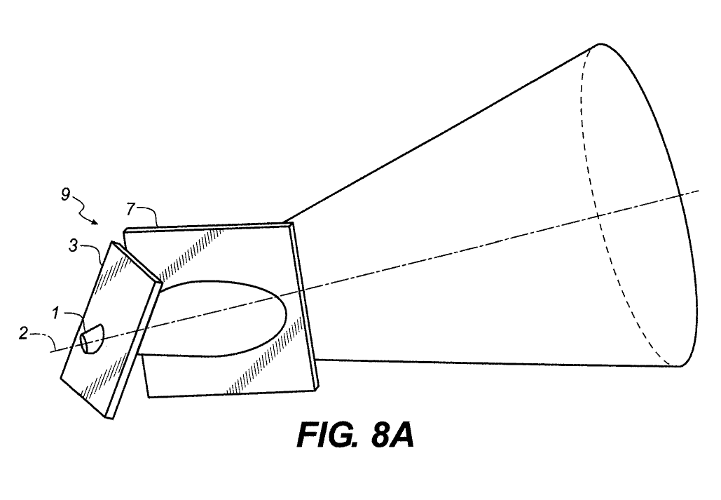

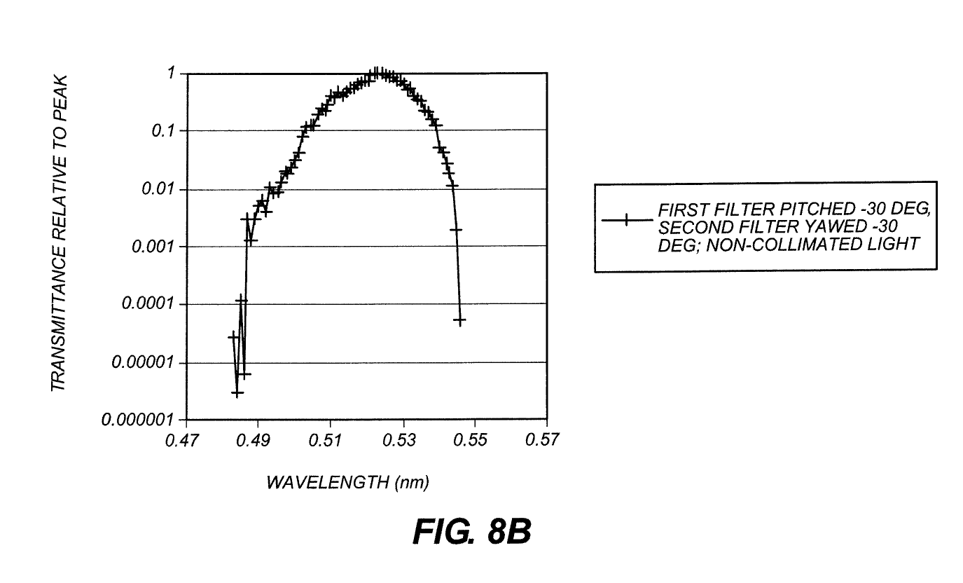

FIG. 8A shows a preferred embodiment wherein two identical filters are intersecting unpolarized non-collimated light path 1, one filter 3 at a pitch angle of −30 degrees and the other filter 7 at a yaw angle of −30 degrees with respect to incident light path 2. In this configuration the transmitted light path axis undergoes a translational shift upon transmission through the first filter and another translational shift of the same magnitude and orthogonal direction upon transmission through the second filter. These two filters comprise a matched pair 9 wherein one filter is tilted by the same amount as the other filter and is tilted along a tilt axis perpendicular to the tilt axis of the other filter. For the purpose simulating a representative configuration, the non-collimated light was given a Lambertian angular weighting within a 15 degree half cone. FIG. 8B shows transmittance relative to peak vs. wavelength of the 542 nm central wavelength, 20 nm bandpass filter as described in FIGS. 1A and B for the configuration in FIG. 8A as simulated using a circular grid source. FIG. 8B shows that the resulting bandwidth is decreased compared to the bandwidth of the configuration shown in FIGS. 5A and 6A. This is because any given light ray transmitted through the first filter at a pitch angle magnitude of the absolute value of (−30+x) degrees and a yaw angle magnitude of the absolute value of y degrees is incident upon the second filter at a pitch angle magnitude of the absolute value of x degrees and a yaw angle magnitude of the absolute value of (−30+y) degrees, where x and y are between −15 degrees and 15 degrees. Therefore the S polarization components of the light rays transmitted by the first filter are the P polarization components of the light rays incident upon the second filter, and the P polarization components of the light rays transmitted by the first filter are the S polarization components of the light rays incident upon the second filter. Therefore light rays that are transmitted by the first filter, with magnitudes of angles of incidence that are so large such that transmission is not common for both S and P polarization components, are rejected by the second filter.

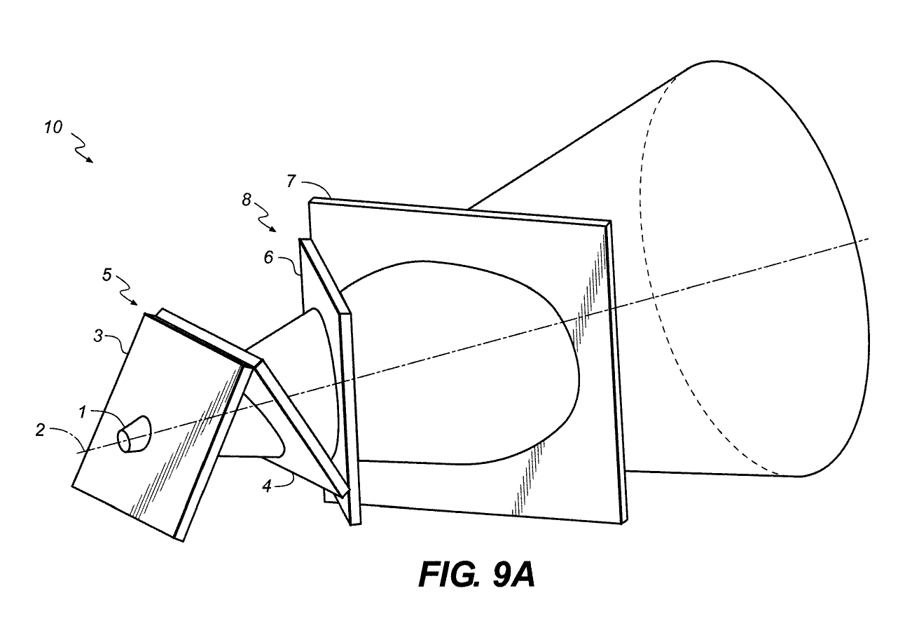

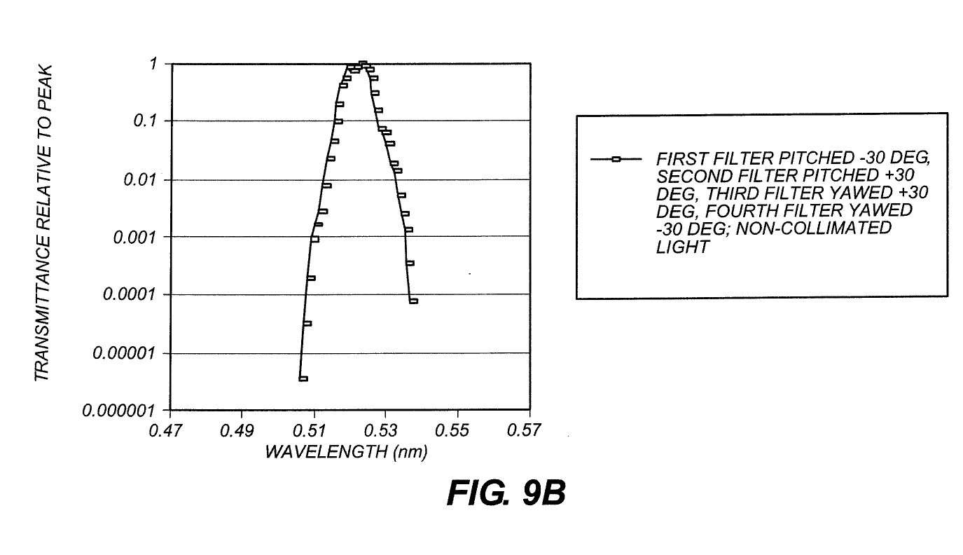

FIG. 9A shows another embodiment wherein four interleaved, identical filters are intersecting unpolarized non-collimated light path 1, one input filter 3 at a pitch angle of −30 degrees, another output filter 4 at a pitch angle of +30 degrees, another input filter 6 at a yaw angle of +30 degrees, and another output filter 7 at a yaw angle of −30 degrees, with respect to incident light path 2. In this configuration the transmitted light path axis undergoes a translational shift upon transmission through the first filter, another translational shift of the same magnitude and opposite direction upon transmission through the second filter, another translational shift of the same magnitude and direction orthogonal to the direction of translational shift provided by the first two filters upon transmission through the third filter, and another translational shift of the same magnitude and opposite direction as the translational shift provided by the third filter upon transmission through the fourth filter, the result being zero net translational shift. Filters 3 and 4 comprise a matched pair 5 oppositely tilted in pitch angle according to the invention. Filters 6 and 7 comprise a matched pair 8 oppositely tilted in yaw angle according to the invention. Matched pairs 5 and 8 comprise a super pair 10 according to the invention wherein one of the matched filter pairs comprises filters that are tilted along a tilt axis perpendicular to the tilt axis of the filters comprising the other of the matched filter pairs. For the purpose simulating a representative configuration, the non-collimated light was given a Lambertian angular weighting within a 15 degree half cone. FIG. 9B shows transmittance relative to peak vs. wavelength of the 542 nm central wavelength, 20 nm bandpass filter as described in FIGS. 1A and B for the configuration in FIG. 9A as simulated using a circular grid source. FIG. 9B shows that the resulting bandwidth is decreased compared to the bandwidth of the configuration shown in FIGS. 7A and 8A. This is because this configuration has the advantages of both the configurations shown in FIGS. 7A and 8A, wherein the advantage of the configuration shown in FIG. 7A is provided for both the pitch and yaw directions.

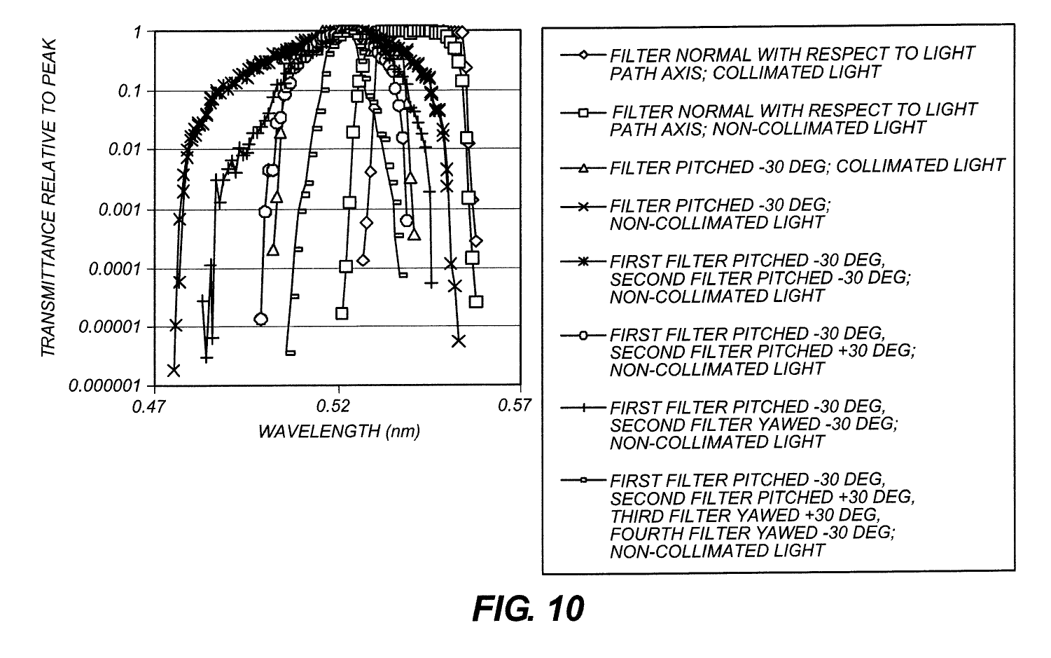

FIG. 10 shows an overlay of the graphs in FIGS. 2B through 9B for convenient comparison.

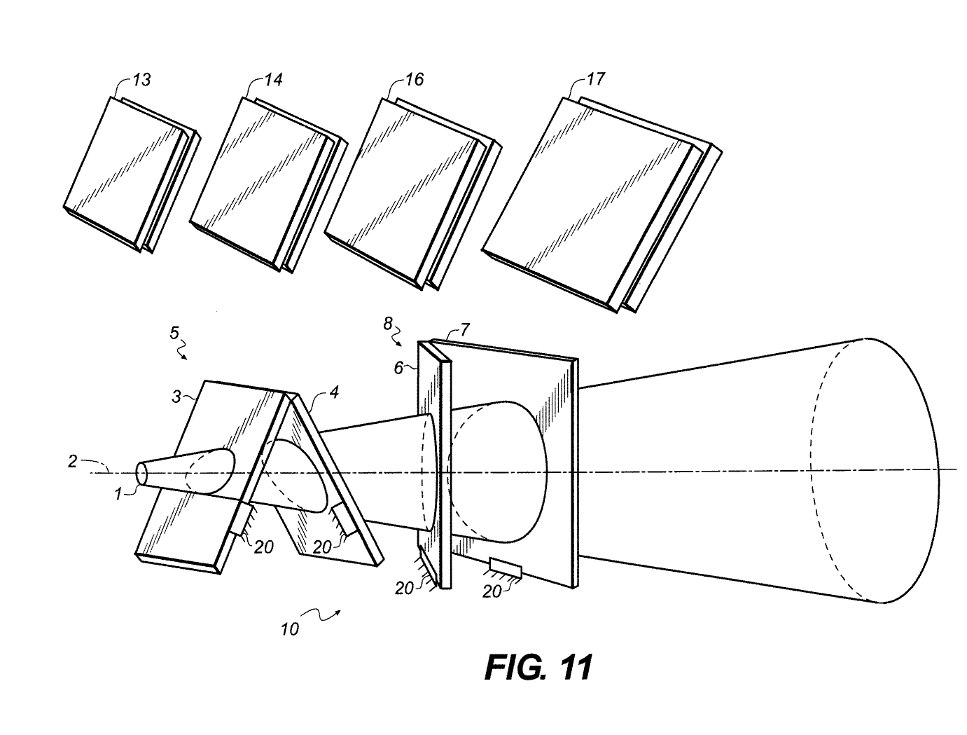

In an embodiment of the present invention, illustrated in FIG. 11, four filters 3, 4, 6 and 7 are selected from loose piece collections of filters 13, 14, 16 and 17 and tilted, resulting in two matched pairs 5 and 8, and one super pair 10. The selection and tilting are made permanent by a fixture 20. As illustrated, filters 3, 4 may have pitch angles that are equal in magnitude and opposite in sign, while filters 6, 7 may have yaw angles that are equal in magnitude and opposite in sign. However, those skilled in the art will appreciate that in some applications, the respective pitch and yaw angles may not be exactly equal in magnitude.

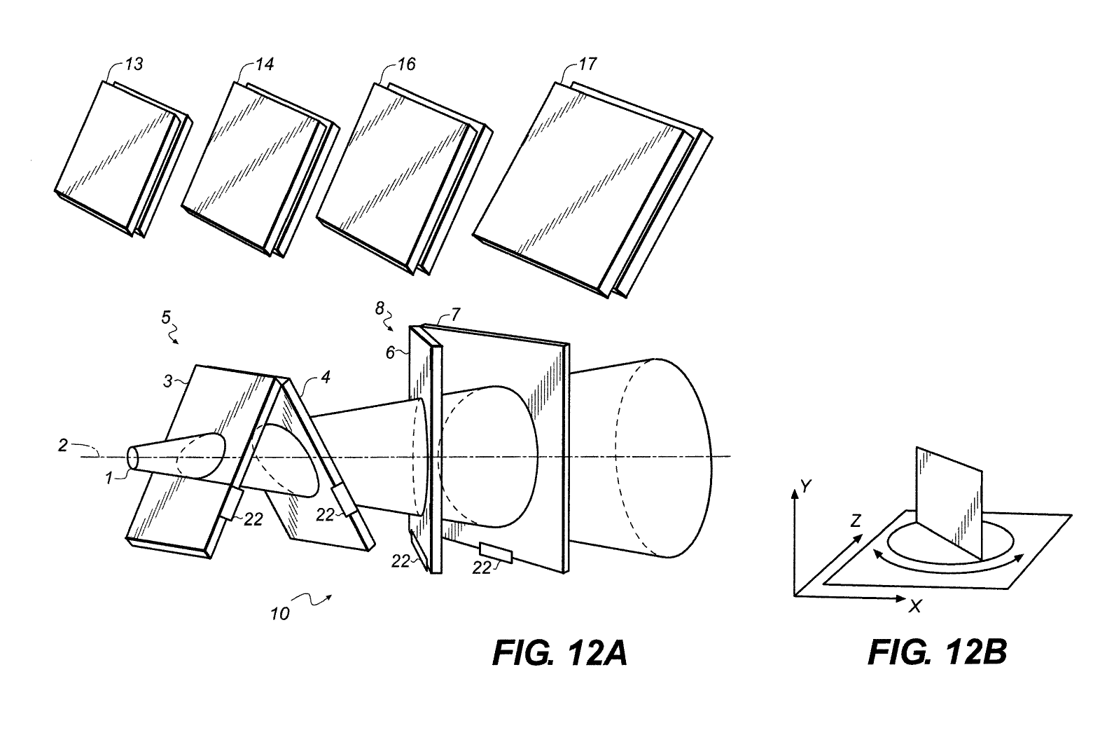

In another embodiment of the present invention illustrated in FIG. 12A, four filters 3, 4, 6 and 7 are selected from loose piece collections of filters 13, 14, 16 and 17 and tilted, resulting in two matched pairs 5 and 8, and one super pair 10. The selection and tilting may be adjustable via a movable fixture 22. As illustrated, filters 3, 4 may have pitch angles that are equal in magnitude and opposite in sign, while filters 6, 7 may have yaw angles that are equal in magnitude and opposite in sign. However, those skilled in the art will appreciate that in some applications, the respective pitch and yaw angles may not be exactly equal in magnitude. As shown schematically in FIG. 12B, fixture 22 may be rotatable, thereby providing mechanical control of the tilt angle of the filters with respect to the light path. Fixture 22 also may allow for both mounting and releasing of filters, thereby providing mechanical control of the filter selection.

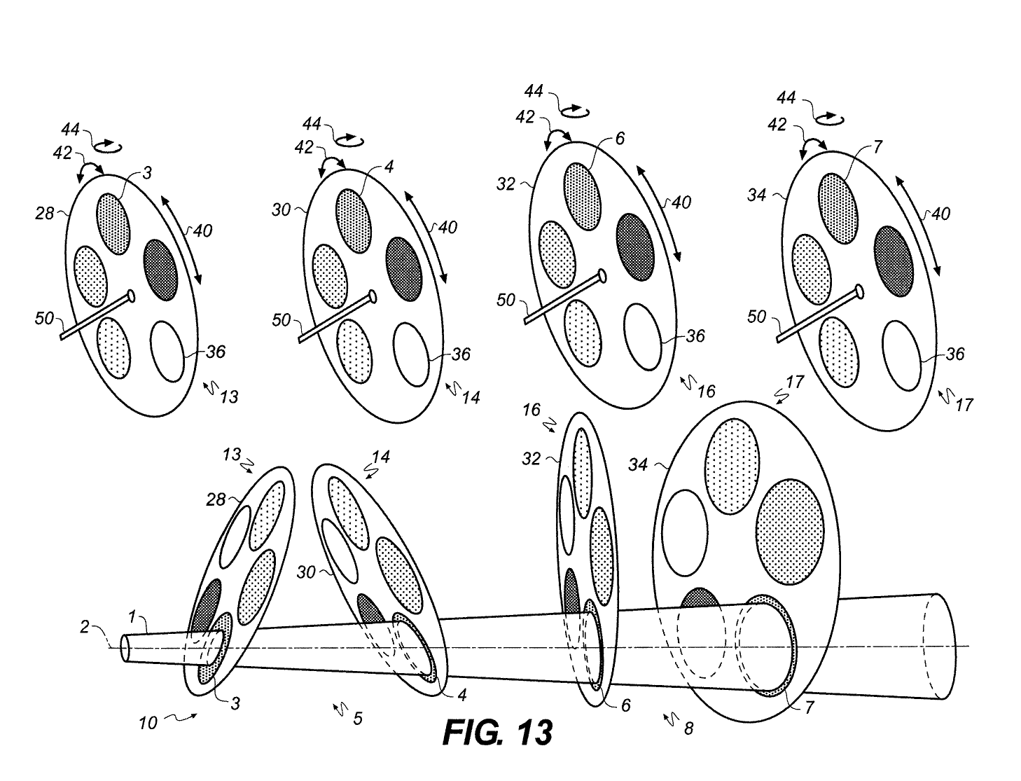

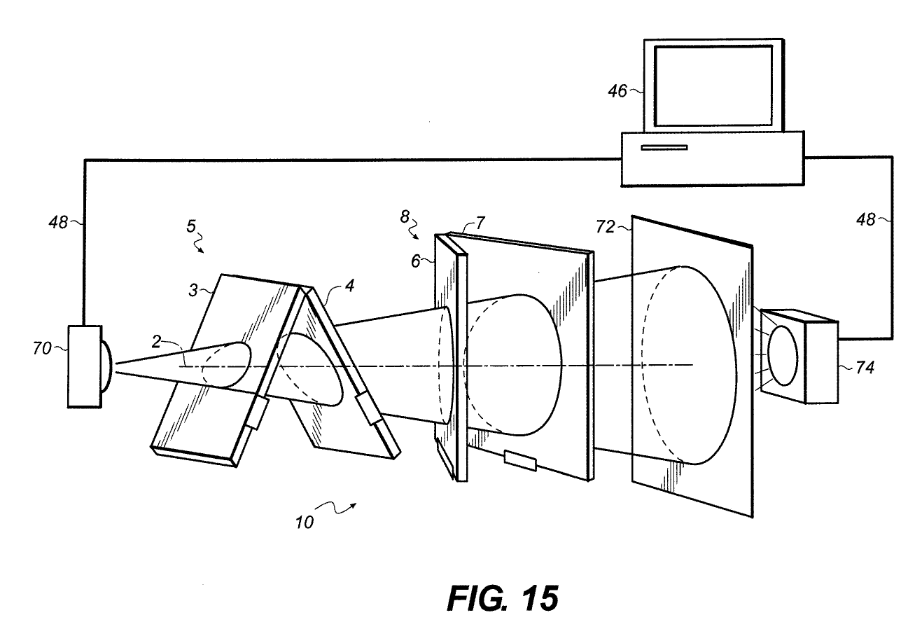

In a third embodiment of the present invention illustrated in FIG. 13, collection 13 of filters 3, 4, 6 and 7 is mounted rotationally on a filter wheel 28. Similarly, the collections 14, 16 and 17 of filters 3, 4, 6 and 7 are mounted rotationally on wheels 30, 32 and 34, respectively. Each filter wheel also has a blank hole 36. Each filter wheel may be moved to a position so that four identical filters mounted on the filter wheel are rotated to intersect unpolarized non-collimated light path 1 as indicted by arrow 40, with one filter 3 at a pitch angle of −30 degrees, another filter 4 at a pitch angle of +30 degrees, another filter 6 at a yaw angle of +30 degrees, and another filter 7 at a yaw angle of −30 degrees, with respect to incident light path 2, resulting in two matched pairs 5 and 8, and one super pair 10. The position of the pitch or tilt of each filter wheel may be selected as indicated by arrow 42 and the position of the yaw of each filter wheel may be selected as indicated by arrow 44. Adjustments of pitch and yaw may be performed via a device 50 and may be automatically controlled via a control computer 46 shown in FIG. 15. The previously mentioned applications of Harder et al and Hall et al disclose features for adjusting tilt of filters that are useful in the present invention.

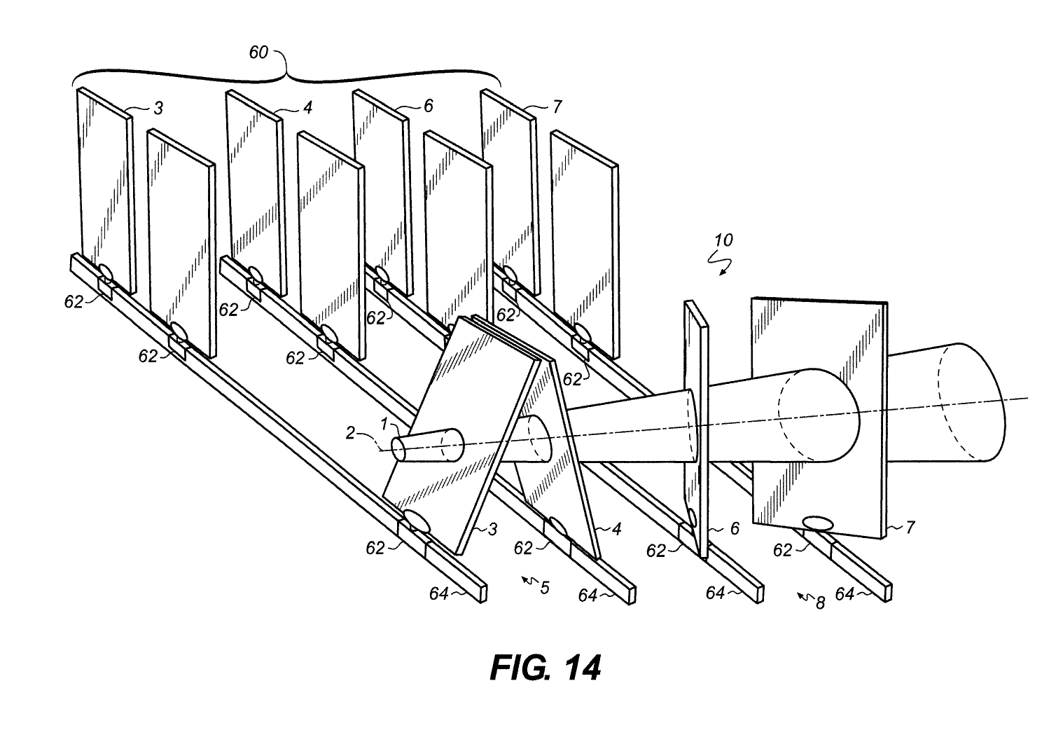

In a fourth embodiment illustrated in FIG. 14, four filters 3, 4, 6 and 7 are selected from collections 60 of filters mounted on translatable sliders 62, resulting in two matched pairs 5 and 8, and one super pair 10. Each of filters 3, 4, 6 and 7 is selected and moved into and out of position via a plurality of translatable sliders 62 running laterally on a corresponding plurality of tracks 64. The selection of each filter, the position of the pitch of each filter and the position of the yaw of each filter are performed via the translatable sliders 62 and may be automatically controlled via the control computer 46 shown in FIG. 15. As illustrated, filters 3, 4 may be set to pitch angles that are equal in magnitude and opposite in sign, while filters 6, 7 may be set to yaw angles that are equal in magnitude and opposite in sign. However, those skilled in the art will appreciate that in some applications, the respective pitch and yaw angles may not be exactly equal in magnitude.

FIG. 15 shows schematically how four selected filters 3, 4, 6 and 7, resulting in two matched pairs 5 and 8, and one super pair 10 are tilted and positioned to intersect light path 2. As illustrated, filters 3, 4 may have pitch angles that are equal in magnitude and opposite in sign, while filters 6, 7 may have yaw angles that are equal in magnitude and opposite in sign. However, those skilled in the art will appreciate that in some applications, the respective pitch and yaw angles may not be exactly equal in magnitude. A light source 70 provides the light that forms an image on a screen 72. The image is captured by a capture device 74. Light source 70 and capture device 70 are connected to a computer 46 via cables 48 and may be automatically controlled by computer 46. Light source 70 may be, but is not limited to, one of monochromatic light emitting diode (LED), a polychromatic LED, a “white” (i.e., phosphor-coated) LED, a halogen lamp or a xenon lamp. Capture device 74 may be, but is not limited to, one of a photodiode, a film camera, a digital camera, or a digital video camera.

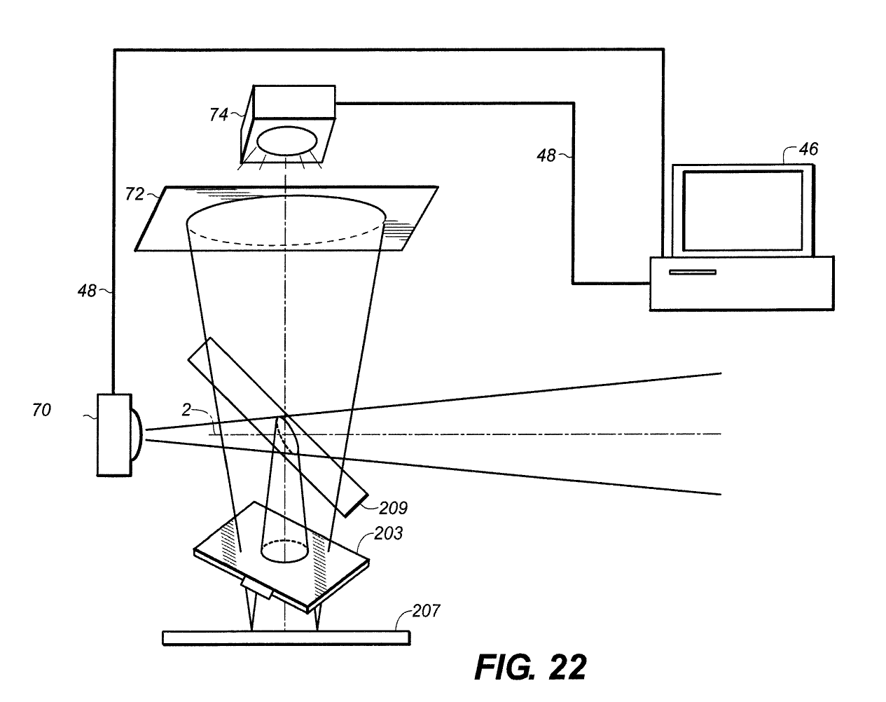

In addition to the foregoing embodiments, a folded configuration, shown in FIG. 22, may also substantially cancel angle-of-incidence dependent spectral broadening and/or polarization dependent spectral broadening of converging or diverging light. FIG. 22 shows an embodiment where non-collimated light from light source 70 travels twice through filter 203 before forming an image on screen 72 and is captured by capture device 74.

From light source 70, light path 2 is first diverted by a partially reflective surface, in this case a polarization-insensitive beamsplitter 209, which directs light path 2 through filter 203, tilted at a pitch angle to achieve the desired wavelength transmission. Light path 2 then travels toward mirror 207, and is reflected back through filter 203 at a pitch angle of opposite sign. Based on these angles of opposite sign, light rays with wavelengths longer than the central wavelength that are transmitted on the first pass through filter 203 because of a relatively smaller magnitude of the angle of incidence are rejected on the second pass back through filter 203 because of a relatively larger magnitude of angle of incidence, while light rays with wavelengths shorter than the central wavelength that are transmitted through filter 203 because of a relatively larger magnitude of angle of incidence are rejected on the second pass through the filter because of a relatively smaller magnitude of angle of incidence.

Advantageously, because there is not a substantial difference for the S and P polarization components, the resulting transmission spectrum is not further broadened. After first path of light 216 passes through filter 203 and second path of light passes back through filter 203, the light is once again directed through the polarization-insensitive beamsplitter and toward the screen 72. Light source 70 and capture device 74 are connected to computer 46 via cables 48 and may be automatically controlled by computer 46. Light source 70 may be, but is not limited to, one of monochromatic light emitting diode (LED), a polychromatic LED, a “white” (i.e., phosphor-coated) LED, a halogen lamp or a xenon lamp. Capture device 74 may be, but is not limited to, one of a photodiode, a film camera, a digital camera, or a digital video camera.

Additionally, the optical filters used in any of the foregoing embodiments may be replaced with filters that exhibit substantially no polarization splitting. Filters with this quality include those commercially available from Semrock, Inc. under the trademark VersaChrome. Examples of VersaChrome filters include (a) Semrock Part Number TBP01-440/16-25x36 (which has a CWL Range of 390-440 nm when tilted from 60 degrees to 0 degrees, and >90% average transmission over a 16 nm bandwidth), (b) Semrock Part Number TBP01-490/15-25x36 (which has a CWL Range of 440-490 nm when tilted from 60 degrees to 0 degrees, and >90% average transmission over a 15 nm bandwidth, (c) Semrock Part Number TBP01-550/15-25x36 (which has a CWL Range of 490-550 nm when tilted from 60 degrees to 0 degrees, and >90% average transmission over a 15 nm bandwidth, (d) Semrock Part Number TBP01-620/14-25x36 (which has a CWL Range of 550-620 nm when tilted from 60 degrees to 0 degrees, and >90% average transmission over a 14 nm bandwidth, and (e) Semrock Part Number TBP01-700/13-25x36 (which has a CWL Range of 620-700 nm when tilted from 60 degrees to 0 degrees, and >90% average transmission over a 13 nm bandwidth.

Such filters substantially eliminate the polarization dependence of the transmission spectra as a function of angle. Further, they offer wavelength tunability over a very wide range of wavelengths by adjusting the angle of incidence with essentially no change in spectral performance. For example, with a tuning range of greater than 12% of the normal-incidence wavelength (by varying the angle of incidence from 0 degrees to 60 degrees), only five Versachrome filters are needed to cover the full visible spectrum. VersaChrome tunable filters filters offer an average transmission greater than 90% with steep edges and wideband blocking of bandpass for applications like fluorescence imaging. More particularly, such filters provide a steep edge absorption at angles of incidence ranging in magnitude from 0° to 60° and are capable of producing a substantially uniform transmission spectrum.

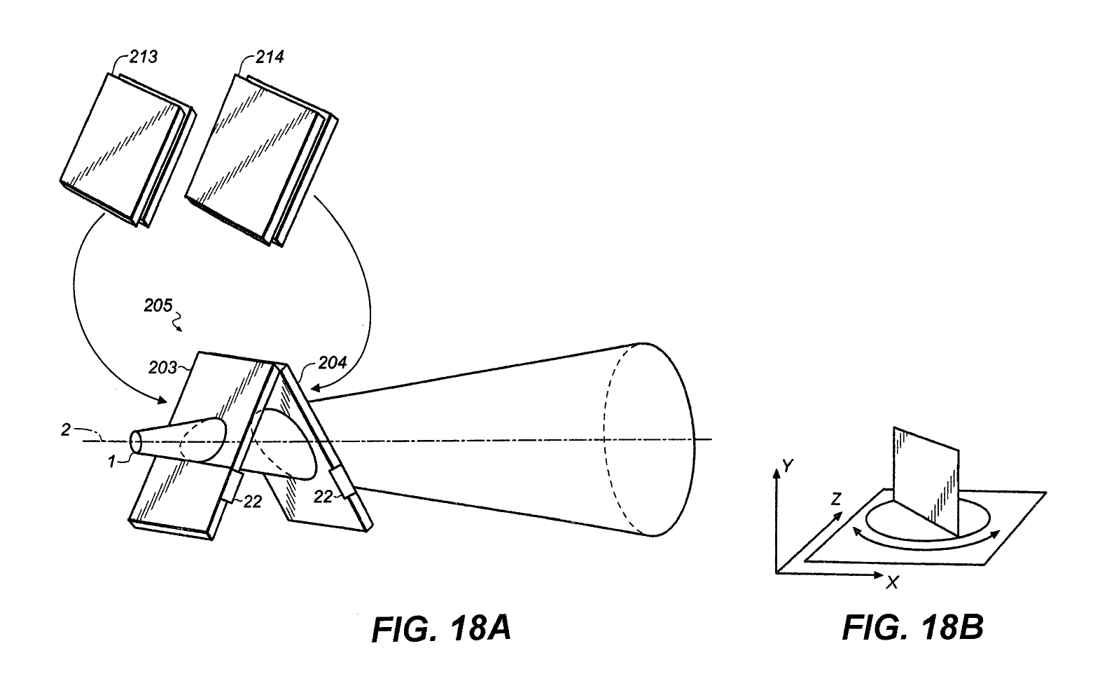

When Versachrome filters are employed, the second pair of optical filters shown in FIGS. 9A, 11, 12A, 13, 14 and 15 is unnecessary. Embodiments employing Versachrome filters are shown at FIGS. 18-21.

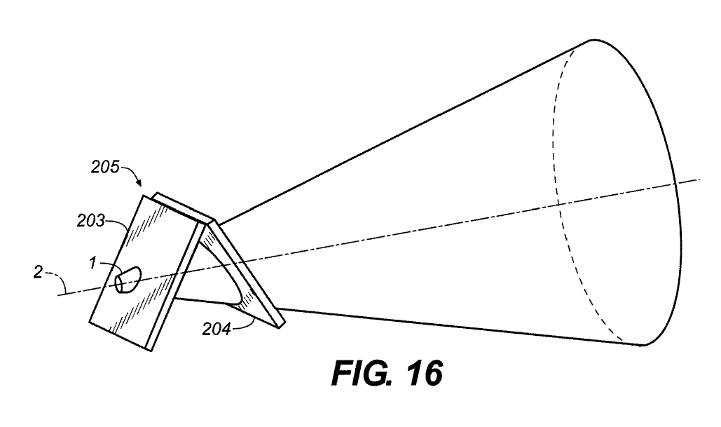

FIG. 16 shows an embodiment where two identical VersaChrome filters are intersecting unpolarized non-collimated light path 1, with first VersaChrome filter 203 positioned at a pitch angle of −30 degrees and second VersaChrome filter 204 positioned at a pitch angle of +30 degrees with respect to incident light path 2. First light path 216 intersects first VersaChrome filter 203 and second light path 218 intersects second VersaChrome filter 204. In this configuration, the transmitted light path axis undergoes a translational shift upon transmission through first VersaChrome filter 203 and another translational shift of the same magnitude and opposite direction upon transmission through second VersaChrome filter 204, the result being zero net translational shift. These two VersaChrome filters comprise a matched VersaChrome pair 205 oppositely tilted in pitch angle according to the invention.

The resulting bandwidth is decreased compared to the bandwidth of known configurations. This is because any given light ray transmitted through first VersaChrome filter 203 at a pitch angle magnitude of the absolute value of (−30+x) degrees is incident upon second VersaChrome filter 204 at a pitch angle magnitude of the absolute value of (30+x) degrees, where x is between −15 degrees and 15 degrees. Therefore some light rays with wavelengths longer than the central wavelength are transmitted by first VersaChrome filter 203 because of a relatively smaller magnitude of angle of incidence but are rejected by second VersaChrome filter 203 because of a relatively larger magnitude of angle of incidence; and some light rays with wavelengths shorter than the central wavelength are transmitted by first VersaChrome filter 203 because of a relatively larger magnitude of angle of incidence but are rejected by second VersaChrome filter 204 because of a relatively smaller magnitude of angle of incidence. Advantageously, owing to the fact that there is not a substantial difference for the S and P polarization components, the resulting transmission spectrum is not further broadened.

Hence, unlike the configuration shown in FIG. 9A, there is no substantial benefit to adding a second pair of VersaChrome filters tilted in an orthogonal direction relative to the first pair. Thus, advantageously, angle-tunable minimized bandwidth is provided by an embodiment employing a single pair of VersaChrome filters, thereby providing higher overall transmission and reduced complexity.

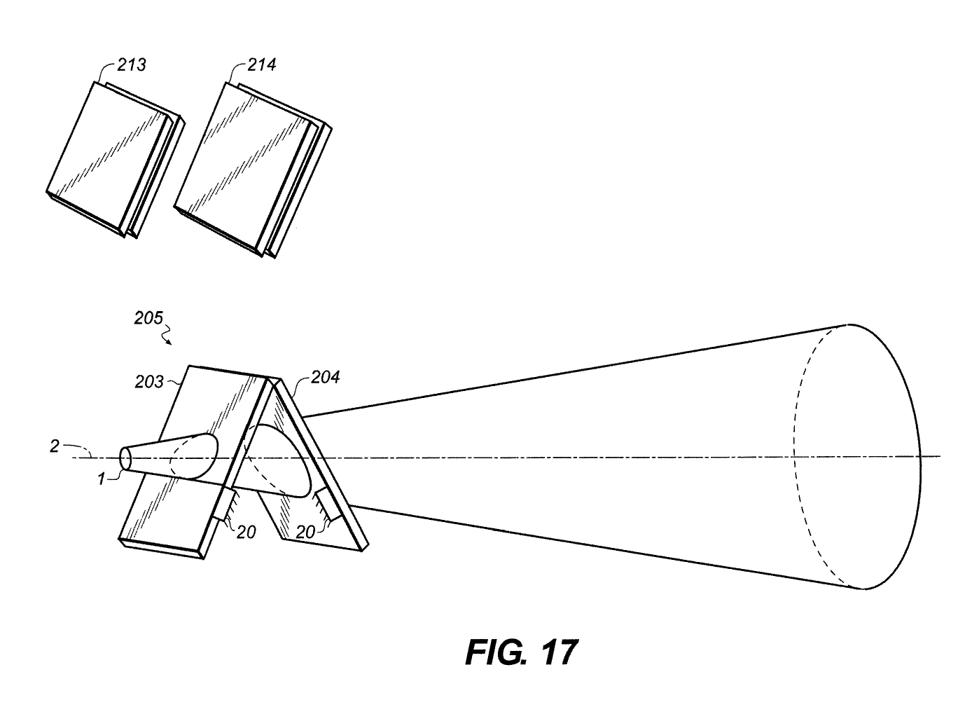

In addition, Versachrome filters 203 and 204 may have pitch angles that are equal in magnitude and opposite in sign. As illustrated in FIGS. 17 and 18A, two VersaChrome filters 203 and 204 are selected from loose piece collections and tilted, resulting in a matched VersaChrome pair 205. The selection and tilting are made permanent by fixture 20. As illustrated, VersaChrome filters 203, 204 may be positioned so that they have pitch angles that are equal in magnitude and opposite in sign. Here again, first path of light 216 passes through first VersaChrome filter 203 and second path of light 218 passes through second VersaChrome filter 204.

However, those skilled in the art will appreciate that in some applications, the pitch angles may not be exactly equal and in magnitude. As shown schematically in FIG. 18B, fixture 22 may be rotatable, thereby providing mechanical control of the tilt angle of the filters with respect to the light path. Fixture 19 also may allow for both mounting and releasing of filters, thereby providing mechanical control of filter selection.

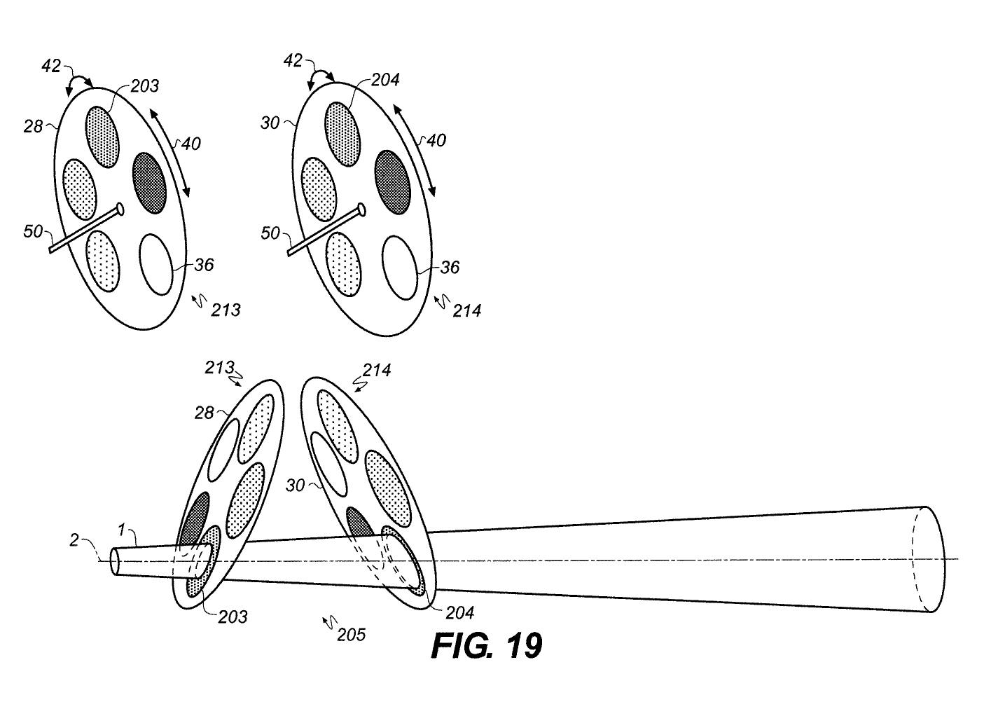

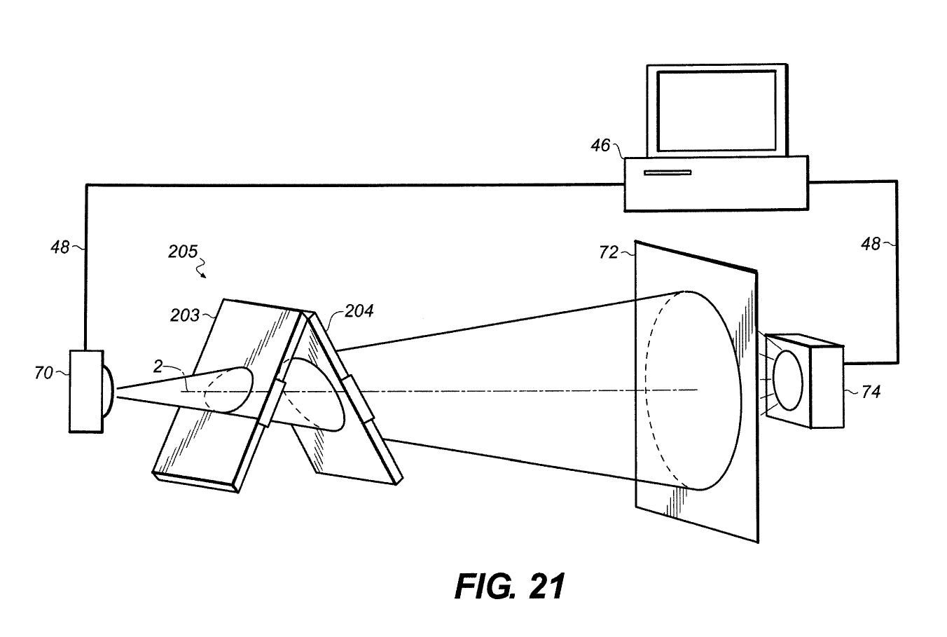

The VersaChrome filters or a collection of Versachrome filters may also be mounted rotationally on a filter wheel 28, as shown in FIG. 19. Each filter wheel 28 comprises a blank hole 36, and may be positioned so that a plurality of filters mounted on the filter wheel are rotated to intersect unpolarized non-collimated light path 1 as indicted by arrow 40, with first VersaChrome filter 203 at a pitch angle of −30 degrees, and second VersaChrome filter 204 at a pitch angle of +30 degrees, with respect to incident light path 2, resulting in a matched VersaChrome pair 205. The position of the pitch or tilt of each filter wheel may be selected as indicated by arrow 42, such that first path of light 216 passes through a first filter and second path of light 218 passes through a second filter. Adjustments of pitch may be performed via device 50 and may be automatically controlled via a control computer 46, shown in FIG. 21. The previously mentioned applications of Harder et al. and Hall et al. disclose features for adjusting tilt of filters that are useful in the present invention.

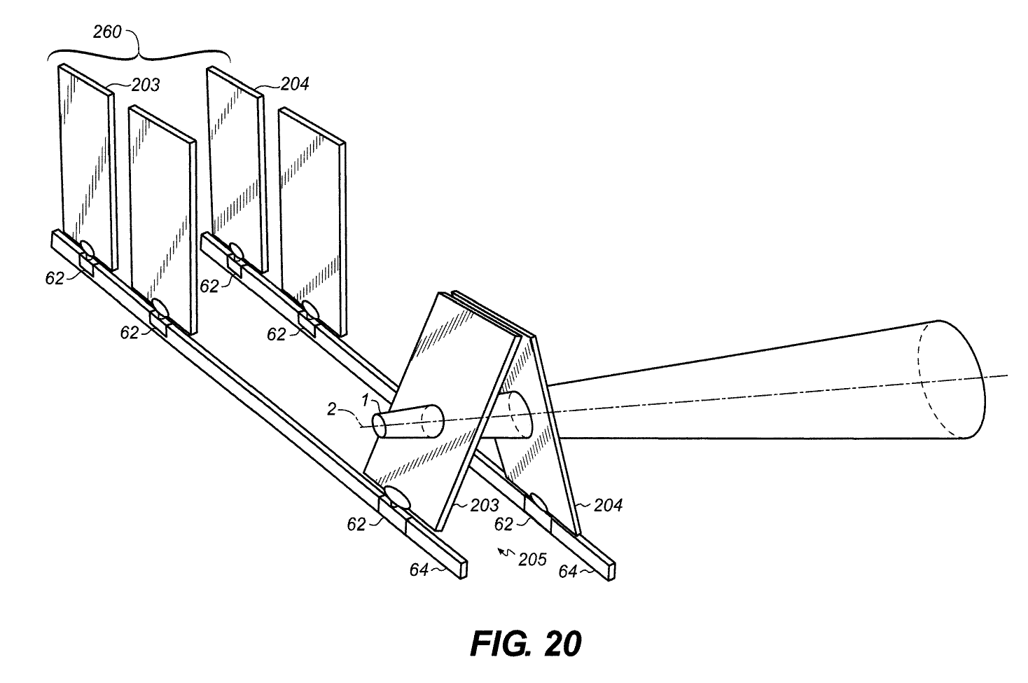

Additionally, four pluralities of VersaChrome filters 203 and 204 may be selected from collections 260 of VersaChrome filters mounted on translatable sliders 62, resulting in a matched VersaChrome pair 205. As shown in FIG. 20, each VersaChrome filter 203 and 204 is selected and moved into and out of position via a plurality of translatable sliders 62 running laterally on a corresponding plurality of tracks 64. The selection of each VersaChrome filter, and the positioning of the pitch of each VersaChrome filter are carried out via the translatable sliders 62 and may be automatically controlled via the control computer 46 shown in FIG. 21. As illustrated, VersaChrome filters 203, 204 may be set to pitch angles that are equal in magnitude and opposite in sign. However, those skilled in the art will appreciate that in some applications, the pitch angles may not be exactly equal and opposite.

FIG. 21 shows schematically how two selected VersaChrome filters 203 and 204, resulting in a matched VersaChrome pair 205 are tilted and positioned to intersect light path 2. First path of light 216 passes through first VersaChrome filter 203 and second path of light 218 passes through second VersaChrome filter 204. As illustrated, VersaChrome filters 203, 204 have pitch angles that are equal in magnitude and opposite in sign. However, those skilled in the art will appreciate that in some applications, the pitch angles may not be exactly equal in magnitude. A light source 70 provides the light that forms an image on a screen 72. The image is captured by a capture device 74. Light source 70 and capture device 74 are connected to computer 46 via cables 48 and may be automatically controlled by computer 46. Light source 70 may be, but is not limited to, one of monochromatic light emitting diode (LED), a polychromatic LED, a “white” (i.e., phosphor-coated) LED, a halogen lamp or a xenon lamp. Capture device 74 may be, but is not limited to, one of a photodiode, a film camera, a digital camera, or a digital video camera.

It will thus be seen that the objects set forth above, and those made apparent from the foregoing description, are efficiently attained. Since certain changes may be made in the foregoing construction without departing from the scope of the invention, it is intended that all matters contained in the foregoing construction or shown in the accompanying drawings shall be interpreted as illustrative and not in a limiting sense.

### PARTS LIST

1 non-collimated light path
2 incident light path axis
3 input filter
4 output filter
5 matched pair
6 input filter
7 output filter
8 matched pair
9 matched pair
10 super pair
11 filter
12 unpolarized collimated light path
13 collection of filters
14 collection of filters
16 collection of filters
17 collection of filters
20 fixed support
22 adjustable support
28 filter wheel
30 filter wheel
32 filter wheel
34 filter wheel
40 arrow
42 arrow
44 arrow
46 computer
48 cable
50 device
60 collections
62 translatable slider
64 track
70 light source
72 screen
74 capture device
100 substrate
110 layers
203 first VersaChrome filter
204 second VersaChrome filter
205 matched VersaChrome pair
207 mirror
209 beamsplitter
211 VersaChrome filter
213 collection of VersaChrome filters
214 collection of VersaChrome filters
216 first path of light
218 second path of light
260 collections

What is claimed is:

1. A tunable spectral filtration device comprising:
at least one optical filter for intersecting a first path of converging or diverging light comprising an axis at a first angle of incidence, said optical filter comprising at least one coating and tiltable over a plurality of angles with respect to said axis;
at least one device positioned to enable a second path of said converging or diverging light to pass through said at least one optical filter at a second angle of incidence, wherein said first angle of incidence is opposite in sign to said second angle of incidence; and
wherein the positioning of said at least one optical filter and said at least one device substantially cancels angle-of-incidence dependent spectral broadening or polarization dependent spectral broadening of said converging or diverging light or both.

2. The tunable spectral filtration device of claim 1, wherein said first angle of incidence is substantially equal in magnitude to said second angle of incidence.

3. The tunable spectral filtration device of claim 1, wherein said at least one device comprises a partially reflective surface for diverting said first path of converging or diverging light and a reflective surface for reflecting said second path of converging or diverging light back through a single optical filter.

4. The tunable spectral filtration device of claim 3, wherein said partially reflective surface comprises a polarization-insensitive beamsplitter and said reflective surface comprises a mirror.

5. The tunable spectral filtration device of claim 4, wherein said at least one optical filter exhibits substantially no polarization splitting.

6. The tunable spectral filtration device of claim 4, wherein said at least one optical filter provides a steep edge absorption at angles of incidence ranging in magnitude from 0° to 60°.

7. The tunable spectral filtration device of claim 4, wherein said at least one optical filter is capable of producing a substantially uniform transmission spectrum.

8. The tunable spectral filtration device of claim 1, wherein said at least one optical filter comprises a first optical filter and said device comprises a second optical filter, wherein said first and second optical filters are positioned in series to intersect said converging or diverging light.

9. The tunable spectral filtration device of claim 8, wherein each of said first and second optical filters is capable of exhibiting substantially no polarization splitting.

10. The tunable spectral filtration device of claim 8, wherein said first and second optical filters include parallel tilt axes and said first optical filter is tilted at an angle with sign opposite to said second optical filter.

11. The tunable spectral filtration device of claim 10, wherein said first optical filter is tilted at an angle with equal magnitude to said second optical filter.

12. The tunable spectral filtration device of claim 8, wherein said first and second optical filters are substantially identical.

13. The tunable spectral filtration device of claim 8, wherein said first and second optical filters are mounted in filter selection members and are selectable from a collection of optical filters mounted in said selection members.

14. The tunable spectral filtration device of claim 1, further comprising a light source selected from the group consisting of a light emitting diode, a multicolor light emitting diode, a phosphor-coated light emitting diode, a halogen lamp, a xenon lamp and combinations thereof.

15. The tunable spectral filtration device of claim 1, wherein the positioning of said at least one optical filter and said at least one device substantially cancels angle-of-incidence dependent spectral broadening.

16. The tunable spectral filtration device of claim 1, wherein the positioning of said at least one optical filter and said at least one device substantially cancels polarization dependent spectral broadening.

17. A tunable spectral filtration device comprising:
at least one optical filter for intersecting a first path of converging or diverging light comprising an axis at a first angle of incidence, said at least one optical filter capable of exhibiting substantially no polarization splitting and tiltable over a plurality of angles with respect to said axis;
at least one device positioned to enable a second path of said converging or diverging light to pass through said at least one optical filter at a second angle of incidence, wherein said first angle of incidence is opposite in sign to said second angle of incidence; and
wherein the positioning of said at least one optical filter and said at least one device substantially cancels angle-of-incidence dependent spectral broadening or polarization dependent spectral broadening of said converging or diverging light or both.

18. The tunable spectral filtration device of claim 17, wherein said first angle of incidence is substantially equal in magnitude to said second angle of incidence.

19. The tunable spectral filtration device of claim 17, wherein said at least one optical filter provides steep edge absorption at angles of incidence ranging in magnitude from 0° to 60°.

20. The tunable spectral filtration device of claim 17, wherein said at least one optical filter is capable of producing a substantially uniform transmission spectrum.

21. The tunable spectral filtration device of claim 17, further comprising a light source selected from the group consisting of a light emitting diode, a multicolor light emitting diode, a phosphor-coated light emitting diode, a halogen lamp, a xenon lamp and combinations thereof.

22. The tunable spectral filtration device of claim 17, wherein the positioning of said at least one optical filter and said at least one device substantially cancels angle-of-incidence dependent spectral broadening.

23. A method of improving the spectral quality of filtered converging or diverging light comprising:
providing converging or diverging light from a light source;
providing a path for said converging or diverging light through at least one optical filter comprising an axis, said at least one optical filter comprising at least one coating and tiltable over a plurality of angles with respect to said axis; and
improving said spectral quality of said converging or diverging light by substantially canceling angle-of-incidence dependent spectral broadening or polarization dependent spectral broadening or both.

24. The method of claim 23, further comprising providing two optical filters and providing two paths for said converging or diverging light through said two optical filters at angles of incidence opposite in sign.

25. The method of claim 24, wherein said angles of incidence have substantially equal magnitude.

26. The method of claim 24, wherein said two filters are substantially identical.

27. The method of claim 23, further comprising providing a partially reflective surface for diverting said converging or diverging light and a reflective surface for reflecting said converging or diverging light back through said at least one optical filter.

28. The method of claim 27, wherein said partially reflective surface is a polarization insensitive beamsplitter and said reflective surface is a mirror.

29. The method of claim 23, wherein said step of providing a path causes substantially no polarization splitting.

30. The method of claim 23, further comprising providing steep edge absorption at angles of incidence ranging in magnitude from 0° to 60°.

31. The method of claim 23, wherein said optical filter is capable of producing a substantially uniform transmission spectrum.

32. The method of claim 23, further comprising providing a light source selected from the group consisting of a light emitting diode, a multicolor light emitting diode, a phosphor-coated light emitting diode, a halogen lamp, a xenon lamp and combinations thereof.

33. A tunable spectral filtration device comprising:
a first optical filter for intersecting a first path of converging or diverging light comprising an axis at a first angle of incidence, said optical filter exhibiting substantially no polarization splitting and tiltable over a plurality of angles with respect to said axis;
a second optical filter positioned to intersect a second path of converging or diverging light at a second angle of incidence, said second optical filter exhibiting substantially no polarization splitting and tiltable over a plurality of angles with respect to said axis, wherein said first angle of incidence is opposite in sign to said second angle of incidence; and
wherein the positioning of said first and second optical filters substantially cancels angle-of-incidence dependent spectral broadening.

34. The tunable spectral filtration device of claim 33, wherein said first angle of incidence is substantially equal in magnitude to said second angle of incidence.

35. The tunable spectral filtration device of claim 33, wherein said at least one optical filter provides a steep edge absorption at angles of incidence ranging in magnitude from 0° to 60°.

36. The tunable spectral filtration device of claim 33, wherein said at least one optical filter is capable of producing a substantially uniform transmission spectrum.

37. The tunable spectral filtration device of claim 33, wherein said first and second optical filters include parallel tilt axes and said first optical filter is tilted at an angle with sign opposite to said second optical filter.

38. The tunable spectral filtration device of claim 33, wherein said first optical filter is tilted at an angle with equal magnitude to said second optical filter.

39. The tunable spectral filtration device of claim 33, wherein said first and second optical filters are substantially identical.

40. The tunable spectral filtration device of claim 33, further comprising a light source selected from the group consisting of a light emitting diode, a multicolor light emitting diode, a phosphor-coated light emitting diode, a halogen lamp, a xenon lamp and combinations thereof.

41. The tunable spectral filtration device of claim 33, wherein the positioning of said at least one optical filter and said at least one device substantially cancels angle-of-incidence dependent spectral broadening.

42. A tunable spectral filtration device comprising:
at least one optical filter for intersecting a path of converging or diverging light comprising an axis, said optical filter comprising at least one coating and tiltable over a plurality of angles with respect to said axis;
a partially reflective surface positioned to redirect said converging or diverging light;
a reflective surface positioned to reflect said converging or diverging light back through said optical filter; and
wherein the positioning of said at least one optical filter and said partially reflective and reflective surfaces cancels angle-of-incidence dependent spectral broadening or polarization dependent broadening of said converging or diverging light or both.

43. The tunable spectral filtration device of claim 42, wherein said first angle of incidence is substantially equal in magnitude to said second angle of incidence.

44. The tunable spectral filtration device of claim 42, wherein said partially reflective surface comprises a polarization-insensitive beamsplitter and said reflective surface comprises a mirror.

45. The tunable spectral filtration device of claim 42, wherein said at least one optical filter exhibits substantially no polarization splitting.

46. The tunable spectral filtration device of claim 42, wherein said at least one optical filter provides a steep edge absorption at angles of incidence ranging in magnitude from 0° to 60°.

47. The tunable spectral filtration device of claim 42, wherein said at least one optical filter is capable of producing a substantially uniform transmission spectrum.

48. The tunable spectral filtration device of claim 42, further comprising a light source selected from the group consisting of a light emitting diode, a multicolor light emitting diode, a phosphor-coated light emitting diode, a halogen lamp, a xenon lamp and combinations thereof.

49. The tunable spectral filtration device of claim 42, wherein the positioning of said at least one optical filter and said partially reflective and reflective surfaces substantially cancels angle-of-incidence dependent spectral broadening.

50. The tunable spectral filtration device of claim 42, wherein the positioning of said at least one optical filter and said partially reflective and reflective surfaces substantially cancels polarization dependent spectral broadening.
